(19) United States
(12) Patent Application Publication
(10) Pub. No.: US 2011/0010415 A1
(43) Pub. Date: Jan. 13, 2011

(54) PERSONAL INFORMATION BANK SYSTEM

(75) Inventor: Shoji KODAMA, St. Thomas Walk (SG)

Correspondence Address: BRUNDIDGE & STANGER, P.C., 2318 MILL ROAD, SUITE 1020, ALEXANDRIA, VA, 22314, US

(73) Assignee: Hitachi, Ltd.

(21) Appl. No.: 12/501,786

(22) Filed: Jul. 13, 2009

(51) Int. Cl. G06F 15/16; G06F 3/048

(52) U.S. Cl. 709/203; 715/763

(57) ABSTRACT

A personal information bank system including a plurality of websites, each being provided by a service system which is connected to a network and each providing a service, a plurality of clients, each accessing the websites via the network to permit a user to use the services provided by the websites, collecting logs of use by the user of the services and logs of user activity data, and transmitting the logs, and a personal information bank which collects the transmitted logs, analyzes the logs and based on the analysis, determines a personal profile for each user, and stores the personal profile for each user in a personal profile database. In the invention each website accesses the personal profile database to retrieve a personal profile of a user using the service and recommends a product or service to the user based on the retrieved personal profile.

### BACKGROUND OF THE INVENTION

The present invention relates generally to a personal information bank. More particularly, the present invention relates to a personal information bank which collects different types of logs from users into a central location and provides personal profiles of the users analyzed from the collected logs to external web service companies.

In web services, personalized services are becoming more and more attractive to web service providers. The technology that makes personalized services possible estimates preferences and interests of a customer according to a personal profile of the customer. The personal profile is developed by analyzing inputs from the customer. Using the personal profile items can be recommended to the customer that more closely match the personal profile, thereby increasing the possibility that the customer would select the recommended items for purchase. The personalized services can be utilized in an advertisement, an online shopping site, and so on.

In the current web services, access logs collected on a web site are used as the inputs from the customers. When a customer selects an item presented on a web page, the selected item is recorded as an access log at the web site and an analysis program guesses that this customer may be interested in a product category related to the selected item. Accordingly, the web site recommends other items in the same product category. The accuracy of the estimated personal profile depends on the quality and the quantity of the inputs from customers and the algorithms of the analysis programs.

FIG. 1 illustrates current conventional architecture of a web service system. As per FIG. 1 personal devices such as a personal computer 0119, 0123 and a mobile phone 0121 can be used in the web service, wherein each personal device 0119, 0123, 0121 is equipped with a web browser 0118, 0120, 0122 to permit a user to interact with a web site 0101, 0109. The interactions between the personal device 0119, 0123, 0121 and web site 0101, 0109 are collected and stored as access logs 0102, 0110 managed by a service system 0105, 0113 of the web site 0101, 0109 and a profile analyzer 0108, 0116 analyzes the access logs and produces a personal profile 0103, 0111 of each of the users. When a user opens a portal page provided by a portal server 0106, 0114 of the web site 0101, 0109, a recommendation engine 0107, 0115 determines recommended items from product information 0104, 0112 based on the analyzed personal profile and the portal page incorporates the recommended items on its page.

One of the problems in current conventional web services is a limitation of the quality and the quantity of the inputs which one web site can collect. This limitation comes from three reasons. 1 The web site is using a web browser to collect user inputs, however the types of inputs are limited to items selected by users at that particular website. 2 The web site can collect access logs only on the web site, specifically the web site can not collect or use access logs on other web sites. 3 The Privacy policy of the web site can limit what data can be collected such that the web site can collect only data which are necessary for providing the services of the web site. Thus, the web site can not collect any other data outside of the services being provided by the web site.

Because of the above noted limitations, there is an increasing demand for technology which collects different types of logs than a web browser.

Another problem of the current conventional web services is a privacy issue. Specifically a user can not control the collected logs about the user at other web sites because the logs are owned by the web service companies of the other web sites and there is no means to access or change or remove such logs by the user. Even if such means are available for the users, the users can not understand any meaning of the logs because such logs are written in languages that are specialized for computing such as binary.

Another problem of the current conventional web services is that only big web service companies can implement personalized services. It is difficult for small companies to build the personalized services. The small companies do not have high enough number of the users to analyze personal profiles effectively or they do not have any skill or time or resource for building personalized services. Thus, there is a demand at the small companies to outsource personalized services to a third party so they can improve their sales easily.

Another problem of the current web services is that a user needs to provide personal information in order to use the free service. However, the user must balance between providing the personal information and the benefits that may be obtain from using the free service. Such balancing does not always favor providing the personal information. The provided personal information should not be more valuable to the user than the quality of the service. Ideally the user should get more from the service company in exchange for providing the personal information, for example, money.

The following are examples of current conventional web services that suffer from the disadvantages noted above

Amazon's Recommendation System is the most successful web site which provides a personalized service. Amazon's Recommendation System recommends products such like music CDs based on a user's purchasing history or a history of clicking items. However, as mentioned above such web service systems have a limitation on the quantity and variety of collected data types.

Facebook Application Program Interface API and another API available on other web services provide a method to access personal information created and uploaded by a user on a web site from external applications. Again, the data available from such web services are limited only to user generated content.

An online storage system stores and protects data in personal computers and mobile phones in the central data center. There is no restriction on types of data stored in the online storage system but typically files such as pictures, video and documents are stored. Access logs to web sites or any other raw data are not the scope of the online storage system and as such is not a provided process. The primary purpose of such online storage system is to provide an extra storage capacity for users and to share files among the users if the users so desire. There is no intention to analyze data across different users and use them for personalized services. Further, there is no method for building a personalized service by using the online storage system. In a case where the online storage system charges a cost for accessing the stored data, web service companies want to select valuable data among the large amount of data before they look inside of the data and pay a cost. However current online storage systems do not have such capability.

### SUMMARY OF THE INVENTION

The present invention provides a personal information bank which collects different types of logs and logs of user activity data from users into a central location and provides personal profiles of the users analyzed from the collected logs to external web service companies so that such companies can improve their services by higher quality logs.

The personal information bank system of the present invention includes a plurality of websites, each website being provided by a service system which is connected to a network and each website providing a service, a plurality of clients, each client accesses the websites via the network to permit a user of the client to use the services provided by the websites, collects logs of use by the user of the services provided by the websites and logs of user activity data, and transmits the logs on the network, and a personal information bank which collects the logs on the network transmitted by the clients, analyzes the logs and based on the analysis determines a personal profile for each user, and stores the personal profile for each user in a personal profile database.

According to the present invention each website accesses the personal profile database to retrieve a personal profile of a user using the service provided by the website and recommends a product or service to the user using the service provided by the website based on the retrieved personal profile.

The personal information bank allows web service companies to use their own profile analyzers executed on the computing farm provided by the personal information banks and stores the results as personal profiles in the storage system of the bank.

The web service companies can not access the logs from outside of the bank but can only access to the analyzed personal profiles. The analyzed personal profiles are written in a common format and their contents are written in human-understandable format. So a user can understand the meaning of data accessed by the web service companies and set appropriate access rights on the personal profiles. The personal information bank can filter personal profiles which are not written in human-understandable format so it reduces the amount of work by the users for checking their profiles.

The personal information bank also provides a common personalized recommendation service for small companies. The personal information bank analyzes personal profiles of the users and recommends items based on product information provided by the small companies. With the personal information bank, it is not necessary for the small companies to have their own personalized recommendation system so they can save money.

In the personal information bank, the users can earn money by providing their logs to the web services. When a web service company accesses a personal profile analyzed from the collected logs, the personal information bank charges a cost for accessing the personal profile. The personal information bank manages the flow of information and money between the web sites and the users.

The personal information bank provides the web service companies a method for minimizing the cost to use the personal profiles. The method enables the web service companies can check a value of personal profiles before it accesses the profiles so they do not need to pay for unnecessary profiles but selectively use valuable profiles for their services. The method also enables a pay per use scheme for using personal profiles. This scheme charges a cost for a web service company only when an item recommended by using a personal profile was selected by a user.

### BRIEF DESCRIPTION OF THE DRAWINGS

The foregoing and a better understanding of the present invention will become apparent from the following detailed description of example embodiments and the claims when read in connection with the accompanying drawings, all forming a part of the disclosure of this invention. While the foregoing and following written and illustrated disclosure focuses on disclosing example embodiments of the invention, it should be clearly understood that the same is by way of illustration and example only and the invention is not limited thereto, wherein in the following brief description of the drawings:

FIG. 1 shows the current architecture of the web service system.

FIG. 2 shows the system architecture of the personal information bank system 0229 in the Embodiment 1.

FIG. 3 shows that cost is determined by two factors.

FIG. 4 shows an example of the Personal Logs database 0214.

FIG. 5 shows an example of the Personal Profiles database 0215.

FIG. 6 shows an example of the Accounting Table 0216.

FIG. 7 shows an example of the Price Table 0217.

FIG. 8 shows an example of the Access Key Table 0218.

FIG. 9 shows an example of the Access Control Table for Personal Log 0231.

FIG. 10 shows an example of the Subscription Table 0203.

FIG. 11 shows an example of the Product Information database 0202.

FIG. 12 is a flow chart of a subscription process.

FIG. 13 is a flow chart of a un-subscription process.

FIG. 14 is a flow chart of a changing an access control setting on the personal information bank.

FIG. 15 shows an example of a Graphical User Interface (GUI) of the access control setting page.

FIG. 16 is a flow chart of a changing a price setting.

FIG. 17 is a flow chart of a data collect agent.

FIG. 18 is a flow chart for uploading a profile analyzer to the computing farm of the personal information bank and executing the profile analyzer by the personal profile client.

FIG. 19 is a flow chart for executing a profile analyzer in more details.

FIG. 20 is a flow chart for realizing Personalized Service.

FIG. 21 is an example of a query message created by a recommendation engine in order to filter personal profiles to be read.

FIG. 22 shows the system architecture of the personal information bank system 2201 in the Embodiment 2.

FIG. 23 is a flow chart for uploading the product information database.

FIG. 24 is a flow chart for executing a profile analyzer and producing personal profiles.

FIG. 25 is a flow chart for the personalized service in the Embodiment 2.

FIG. 26 shows the system architecture of the personal information platform system 2601 in the Embodiment 3.

FIG. 27 shows an example of a service catalogue.

FIG. 28 shows a flowchart of the Main Program.

FIG. 29 shows a flowchart of Discovery function 2603 in more detail.

FIG. 30 shows a flowchart of Subscription function 2610.

FIG. 31 shows a flowchart of an Access Control Setting function 2611.

FIG. 32 shows a flowchart of Data Access Interface 2606.

FIG. 33 shows a flowchart of the Data Collect Interface 2607.

FIG. 34 shows different locations where the service system 0204 can run.

FIG. 35 shows an example of the GUI screen for the details of the personal profile.

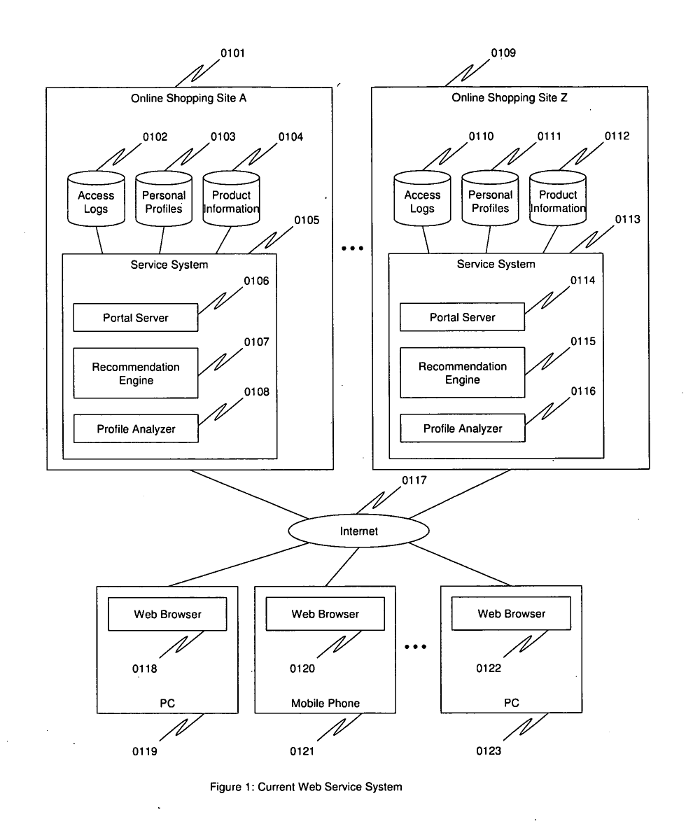

### DETAILED DESCRIPTION OF THE INVENTION

The present invention as will be described in greater detail below provides an apparatus, method and system, particularly, for example, a personal information bank which collects different types of logs from users into a central location and provides personal profiles of the users analyzed from the collected logs to external web service companies so that such companies can improve their services by using higher quality logs. The present invention provides various embodiments as described below. However it should be noted that the present invention is not limited to the embodiments described herein, but could extend to other embodiments as would be known or as would become known to those skilled in the art.

The personal information bank will be described below with respect to the accompanying drawings.

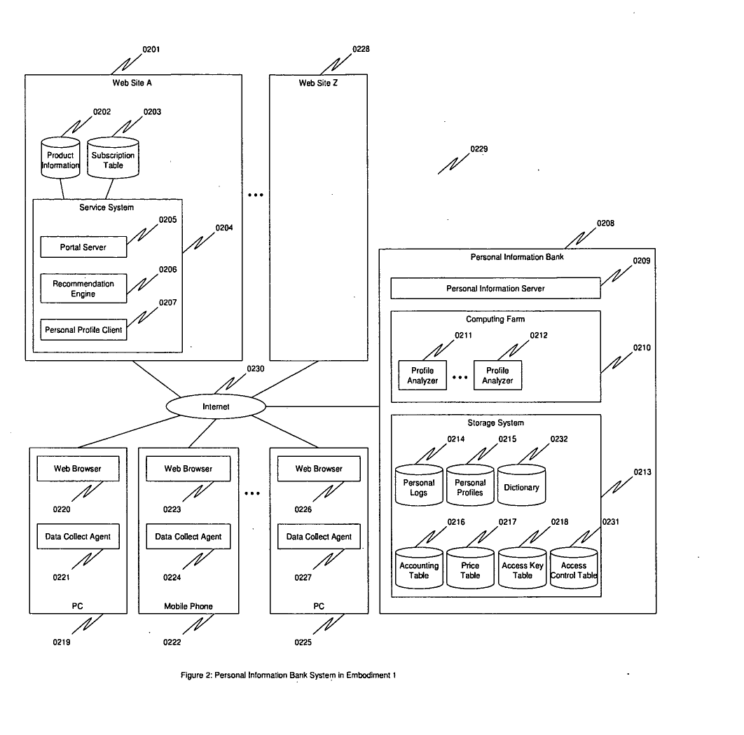

FIG. 2 shows the system architecture of the personal information bank system 0229 in Embodiment 1 of the present invention. The personal information bank system 0229 includes multiple web sites 0201, 0228, multiple clients such as personal computers 0219, 0225 and mobile phones 0222 and a personal information bank 0208. These are connected to the Internet 0230 or some other type of network.

A web site 0201, 0228 provides a portal page personalized to each user. Items such as products, services and advertisements are selected for recommendation to the user based on a personal profile of the user and presented on the portal page.

A portal page is provided by a service system 0204 which is a server computer equipped with a processor, a memory, a network interface and a storage system, wherein the server executes computer programming to provide various services. The service system 0204 has a portal server 0205, a recommendation engine 0206, a personal profile client 0207, a product information database 0202 and a subscription table 0203.

The portal server 0205 generates a portal page for a user and presents a list of recommended items generated by the recommendation engine 0206 on the page. The subscription table 0203 is used for identifying a user. The recommendation engine 0206 selects a set of items from the product information database 0202 based on a personal profile about a user provided by the personal profile client 0207. The product information database 0202 manages information about products provided by the web site 0201, 0228. The personal profile client 0207 acquires a personal profile about a user from the personal information bank.

A client has a web browser 0220, 0223, 0226 and a data collect agent 0221, 0224, 0227. A client also has a processor and memory (not shown). A web browser 0220, 0223, 0226 is software which accesses to one of the web sites 0201, 0228 and loads and shows a portal page on the display of the client. A user can select an item shown on the page and more detailed information about the selected item is provided from the web site 0201, 0228 and shown on the display. The data collect agent 0221, 0224, 0227 is software which is running in background and collects data as a log and sends the log to the personal information bank via the Internet. Each log records information concerning the use by the user of the services provided by the websites 0201, 0228, or user activity data of predefined user activities conducted by the user on the websites 0201, 0228.

The personal information bank includes a personal information server 0209, a computing farm 0210 and a storage system 0213.

The personal information server 0209 collects logs sent from the data collect agents 0221, 0224, 0227 and stores the logs in a Personal Logs database 0214 in the storage system 0213. The personal information server 0209 sends personal profiles stored in the Personal Profiles database 0215 to the personal profile clients 0207 via the Internet.

The personal information server 0209 controls accesses to the logs and the personal profiles 0215 according to security settings by the users. Access control information about the personal logs 0214 is managed by an Access Control Table 0231 and access control information about the personal profiles 0215 is managed by the Personal Profiles database 0215.

The personal profile client 0207 and a profile analyzer 0211, 0212 included in the computing farm 0210 require an access key assigned by the personal information server 0209 when a user subscribed to the web site 0201, 0228 attempts access. The access keys are managed by an Access Key Table 0218.

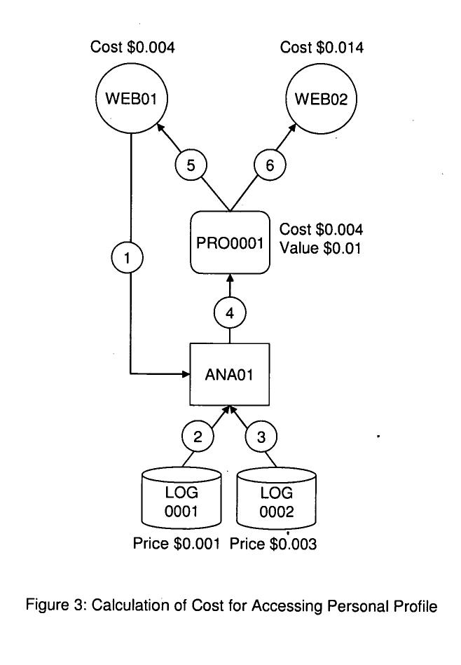

The personal information server 0209 charges a cost for accessing personal profiles 0215 by personal profile clients 0207. The cost is determined by two factors as shown in FIG. 3.

The first factor is a cost for using a personal log in which the price is set in a Price Table 0217. In FIGS. 3 and 2 logs LOG0001 and LOG0002 are used for producing a personal profile PRO0001 by a profile analyzer ANA01. Profile analyzer ANA01 is provided by and executed by a web site WEB01. A cost for using a personal log is set in each log. A cost of log LOG0001 is $0.001 and a cost of log LOG0002 is $0.003.

The second factor is a value of a personal profile. The profile analyzer 0211, 0212 sets the value according to the content of the profile. If the profile has important information about a user, the value is set to high. The personal profile client 0207 checks the value before it reads the personal profile and accesses to only the profiles which values are higher than a criteria in order to reduce a cost.

In FIG. 3, the value of personal profile PRO0001 is set to $0.01. The total cost for accessing a personal profile is a sum of costs of personal logs 0214 being used for analyzing a personal profile and a value of the personal profile. However, a web site WEB01, WEB02 which pays for computing resources does not need to pay for the second part, i.e. a value of a personal profile. In FIG. 3, web site WEB01 is charged in $0.004 which is a cost for using personal logs 0214. On the other hand, web site WEB02 is charged in $0.014 which is a sum of two parts. Because web site WEB01 pays for computing the personal profile, it can use the personal profile by just paying a cost for the logs used. The value part of the total cost of the personal profile is paid to the web site WEB01, WEB02 which analyzed it. In FIG. 3, $0.01 paid by web site WEB02 goes to web site WEB01 as an earning. The cost for using a personal log is paid to a user of the personal log. The personal information bank charges a fee for a transaction between a web site WEB01, WEB02 and a user and its fee is determined by the amount of the exchanged money. An access log to personal profiles 0215 is recorded in an Accounting Table 0216.

The computing farm 0210 is a cluster of computers on which profile analyzers 0211, 0212 are executed. Each computer of the cluster includes a processor and memory. The personal profile client 0207 can upload a program of a profile analyzer 0211, 0212 on the computing farm 0210 and initiates an execution of the program via the Internet. The profile analyzer 0211, 0212 reads the logs in the Personal Logs database 0214 and generates and stores personal profiles in the Personal Profiles database 0215. The computing farm 0210 charges a cost for using the computing resources by the profile analyzer 0211, 0212 depending on the period of the execution time.

The storage system 0213 stores databases required by the computing farm 0210 and the personal information server 0209. Such databases include the Personal Logs database 0214, the Personal Profile database 0215, the Access Control Table 0231, the Accounting Table 0216, the Price Table 0217, the Access Key Table 0218 and a Dictionary 0232.

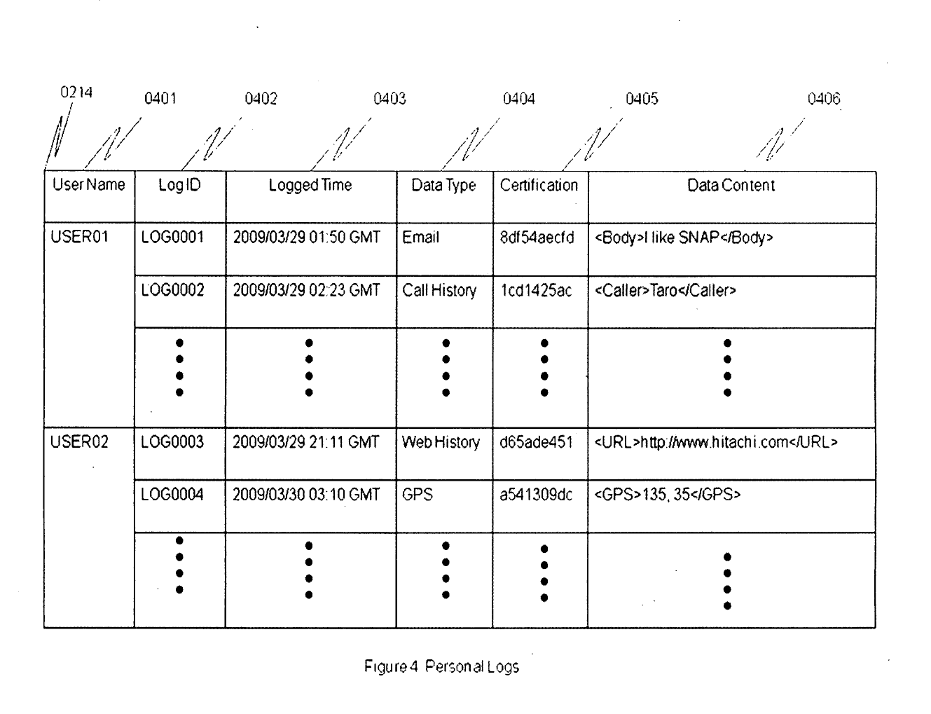

FIG. 4 shows an example of the Personal Logs database (Table) 0214 having a plurality of entries each storing in corresponding relation User Name 0401, Log identifier (ID) 0402, Logged Time 0403, Data Type 0404, Certification 0405 and Data Content 0406. This table stores personal logs 0214 collected by data collect agents 0221, 0224, 0227. A collected log is managed by each user and grouped by User Name. A log ID is assigned to each collected log and a time of data collection is managed in Logged Time. Data Type indicates a type of a collected log such like an email, a call history, a web history, GPS, and so on. Certification stores a certification sent from a data collect agent 0221, 0224, 0227 and the certification validates that a collected log was collected by a certified data collect agent 0221, 0224, 0227 program at a logged time. Such certification is necessary in order to avoid collecting faked data created by bad users. Data Content stores an actual data collected. For example, a message content of an email, a name of a person who made a call, etc.

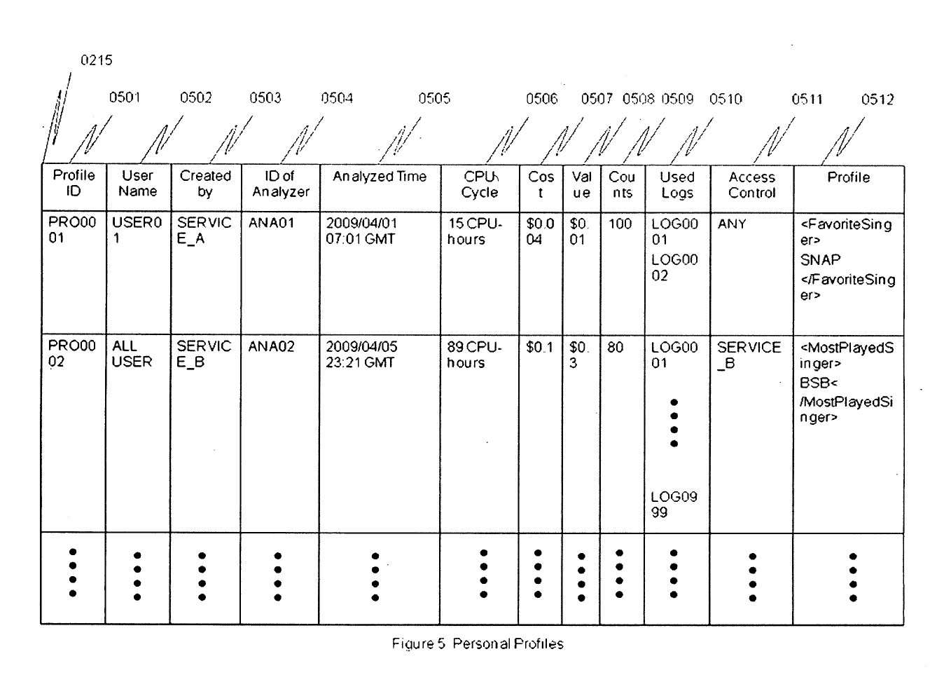

FIG. 5 shows an example of the Personal Profiles database (Table) 0215 having a plurality of entries each storing in corresponding relation Profile ID 0501, User Name 0502, Created by information 0503, ID of Analyzer 0504, Analyzed Time 0505, CPU Cycle 0506, Cost 0507, Value 0508, Counts 0509, Used Logs 0510, Access Control 0511, and Profile 0512. This table stores personal profiles 0215 analyzed by profile analyzers 0211, 0212 and includes multiple columns that represent information of the personal profiles 0215. Profile ID stores a Profile ID assigned to each analyzed personal profile. User Name stores a user name of a user of a personal profile. Created by indicates a Service ID of a web service company which created a personal profile. ID of Analyzer stores a name or an ID of a profile analyzer program. Depending on the profile analyzer 0211, 0212, different personal profiles 0215 are generated so an ID of a profile analyzer program is used for indicating what kinds of personal profiles 0215 are analyzed. Analyzed Time is a time at which a personal profile is analyzed. CPU Cycle is a time length required for executing a profile analyzer 0211, 0212 on the computing farm 0210. Cost is a sum of costs of personal logs 0214 used for analyzing a personal profile. Value is a value set by a profile analyzer 0211, 0212 for a personal profile. Counts is the number of accessed times for a personal profile. Used Logs is a list of log IDs which have been used for analyzing a personal profile. Access Control indicates which web service companies can access to a personal profile. Profile is a content of a personal profile. Example of a personal profile is a favorite singer of a user which is analyzed from a music play history.

Content of Profile is written in XML format and all of used words are written in human-understandable languages. The personal information server 0209 checks if all of the words used in the profile are listed in the Dictionary 0232 before it sends the personal profile to the personal profile client 0207 and any words not listed in the Dictionary 0232 is removed from the profile. It is possible to use natural language processing technology for much intelligent analysis of the content of a profile so it checks if semantics of the content are written in natural language. Dictionary 0232 is a list of keywords and its structure is simple so no example is provided.

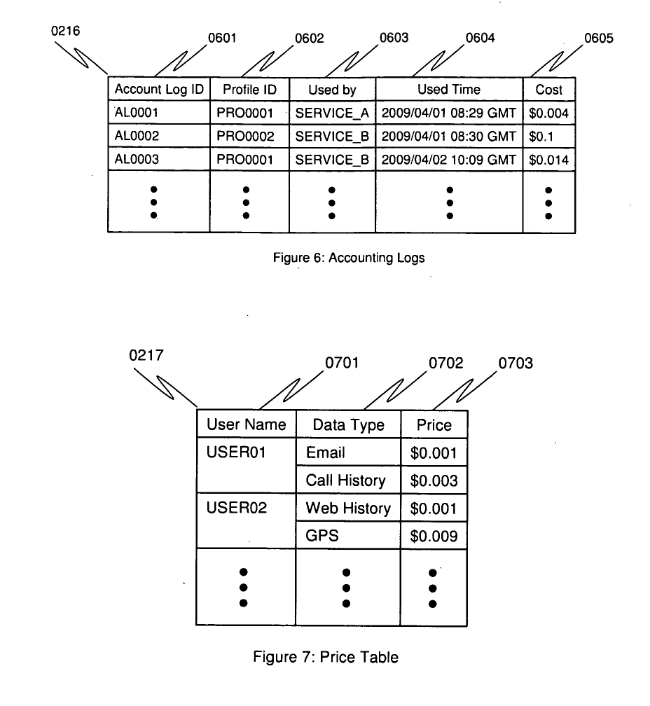

FIG. 6 shows an example of the Accounting Table 0216 having a plurality of entries each storing in corresponding relation Account Log ID 0601, Profile ID 0602, Used by 0603, Used Time 0604 and Cost 0605. This table records an access log to a personal profile and is used for charging costs to the user. An account log ID is assigned for each access log. Profile ID is a profile ID of a personal profile accessed. Used by is a Server ID of a web service company which accessed a personal profile. Used Time is a time at which a personal profile was accessed. Cost is a cost for accessing a personal profile.

FIG. 7 shows an example of the Price Table 0217 having a plurality of entries each storing in corresponding relation User Name 0701, Data Type 0702 and Price 0703. This table manages a price of a personal log for each different type of a log and for each user. The table represents information of the price of personal logs 0214 including User Name 0701, Data Type 0702 and Price 0703. User Name is a name of a user which assigns cost information for logs collected from the user. Data Type is a type of a personal log such like an email, a call history, etc. Price is a cost of a personal log.

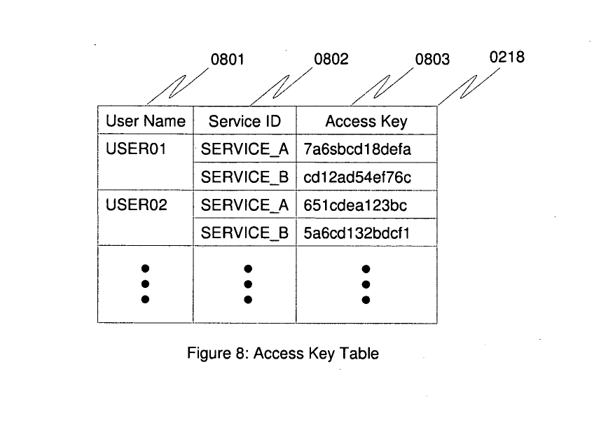

FIG. 8 shows an example of the Access Key Table 0218 having a plurality of entries each storing in corresponding relation User Name 0801, Service ID 0802 and Access Key 0803. This table assigns an access key for each subscription to a web service by a user. For example, when a user, USER01, subscribed to a web service, SERVICE_A, one access key, 7a6sbcd18defa, is assigned for this subscription. The profile analyzer 0211, 0212 executed by this web service, SERVICE_A, uses this access key to access personal logs 0214 of the user, USER01. At the same time, when a personal profile client 0207 of this web service accesses a personal profile of this user, the same access key is required. Different access key is assigned for different service and different users. User Name indicates a name of a user. Service ID is a Service ID of a web service. Service ID is provided by a web service before a subscription. Access Key is an access key assigned to each subscription.

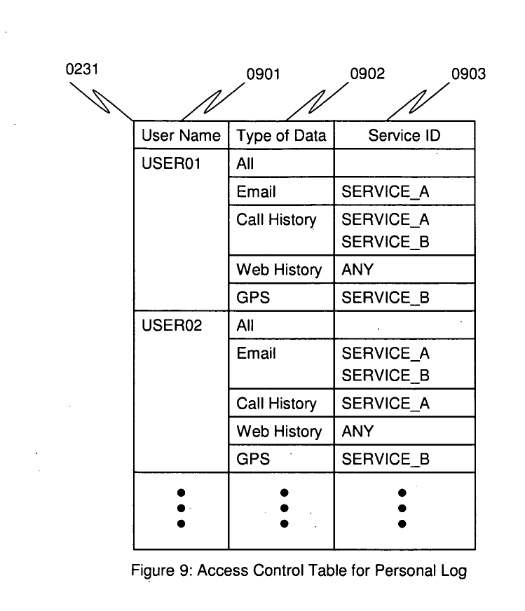

FIG. 9 shows an example of the Access control table 0231 for Personal Log 0231 having a plurality of entries each storing in corresponding relation User Name 0901, Type of Data 0902 and Service ID 0903. This table manages access control information for each different type of personal log and for each user. Only profile analyzers 0211, 0212 which service IDs are allowed in this table can access to permitted personal logs 0214. User Name is a name of a user. Type of Data is a type of a personal log. Service ID is a service ID of a web service. For example, a profile analyzer 0211, 0212 of a web service which service ID is SERVICE_A can access to a personal log of USER01 but the types of the logs are limited only to Email, Call History and Web History. “Any” in Service ID column means any subscribed web services can access to the log. “All” in Type of Data column means same access control settings are applied to all of the data types.

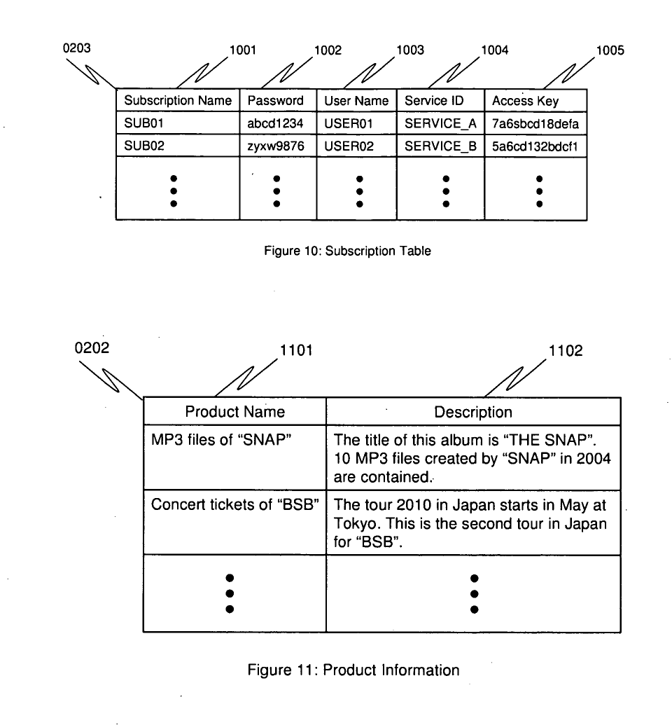

FIG. 10 shows an example of the Subscription Table 0203 having a plurality of entries each storing in corresponding relation Subscription Name 1001, Password 1002, User Name 1003, Service ID 1004 and Access Key 1005. This table manages subscribed users. Before a profile analyzer 0211, 0212 reads a personal log collected from a user or a personal profile client 0207 accesses to a personal profile about a user, the user subscribes to the service provided by the web service company. During the subscription, the user gives a user name used in the personal information bank, a subscription name which is unique in the service, a password for the subscription and an access key assigned by the personal information bank for this subscription. Subscription Table 0203 stores the information in the corresponding columns.

FIG. 11 shows an example of the Product Information database (Table) 0202 having a plurality of entries each storing in corresponding relation Product Name 1101 and Description 1102. This table manages information about products provided by a web service and is used for selecting recommended products by matching a personal profile and descriptions of products. Product Name is a name of a product and is used for identifying a product. Description is information about a product and characterizes the product. In this example, only description is managed as information about a product but it is possible to have more meta data information such like a manufacture of a product, price of a product, performance of a product, etc.

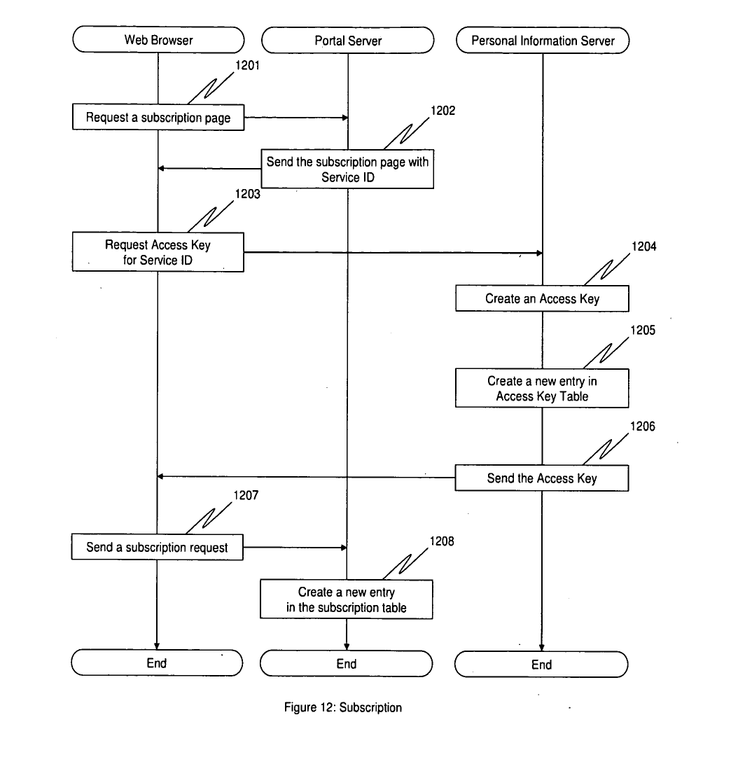

FIG. 12 is a flow chart of a subscription process. It should be noted that flow chart of the subscription process as illustrated in FIG. 12 is representative, for example, of computer programming executed at the client 0219, 0222, 0225, the web site 0201, 0228, and the personal information bank 0208. The computer programming is stored, for example in memory included in each of the client 0219, 0222, 0225, the web site 0201, 0228, and the personal information bank 0208. The subscription process is called when a user launches a web browser 0220, 0223, 0226 to subscribe to a specific web service.

The subscription process proceeds as follows:

Step 1201: A web browser 0220, 0223, 0226 opens a subscription page provided by a portal server 0205 of a web site 0201, 0228 by sending a request for the subscription page to the portal server 0205.

Step 1202: The portal server 0205 sends the requested subscription page with a Service ID which identifies the service, to which the user wishes a subscription, to the web browser 0220, 0223, 0226.

Step 1203: The web browser 0220, 0223, 0226 sends a request for assigning an access key for the service, to which the user wishes a subscription, with the received Service ID to a personal information sever of the personal information bank. In this request, a user name of the user and a Service ID are included.

Step 1204: In response to the request from the web browser 0220, 0223, 0226 the personal information server 0209 creates a unique access key for the service to which the user wishes a subscription.

Step 1205: The personal information server 0209 further creates a new entry in the Access key table 0218 and sets a user name, a Service ID and the assigned Access Key in the entry.

Step 1206: The personal information server 0209 sends back the access key to the web browser 0220, 0223, 0226.

Step 1207: The web browser 0220, 0223, 0226 sends a subscription request to the portal server 0205. The request includes a subscription name of a user, a password, a user name used in the personal information bank, a Service ID and an access key.

Step 1208: The portal server 0205 creates a new entry in the Subscription Table 0203 and sets the received information in the entry.

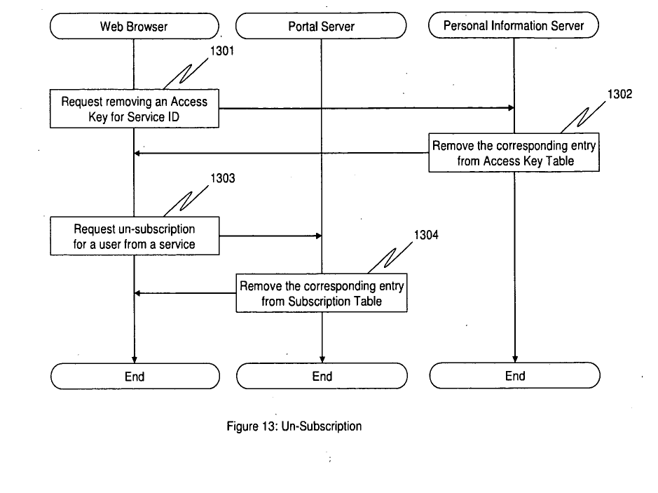

FIG. 13 is a flow chart of an un-subscription process. It should be noted that flow chart of the un-subscription process as illustrated in FIG. 13 is representative, for example, of computer programming executed at the client 0219, 0222, 0225, the web site 0201, 0228, and the personal information bank 0208. The computer programming is stored, for example, in memory included in each of the client 0219, 0222, 0225, the web site 0201, 0228, and the personal information bank 0208. The un-subscription process is called when a user launches a web browser 0220, 0223, 0226 to un-subscribe from a specific service provided by a web site 0201, 0228.

The un-subscription process proceeds as follows:

Step 1301: A web browser 0220, 0223, 0226 sends a request for removing an access key for a Service ID to a personal information server 0209. In the request, a user name and a Service ID are specified.

Step 1302: The personal information server 0209 removes an entry corresponding to the request from the Access key table 0218.

Step 1303: The web browser 0220, 0223, 0226 requests the un-subscription of a service provided by a web site 0201, 0228 to a portal server 0205. In the request, a subscription name is specified.

Step 1304: The portal server 0205 removes an entry corresponding to the request from the Subscription Table 0203.

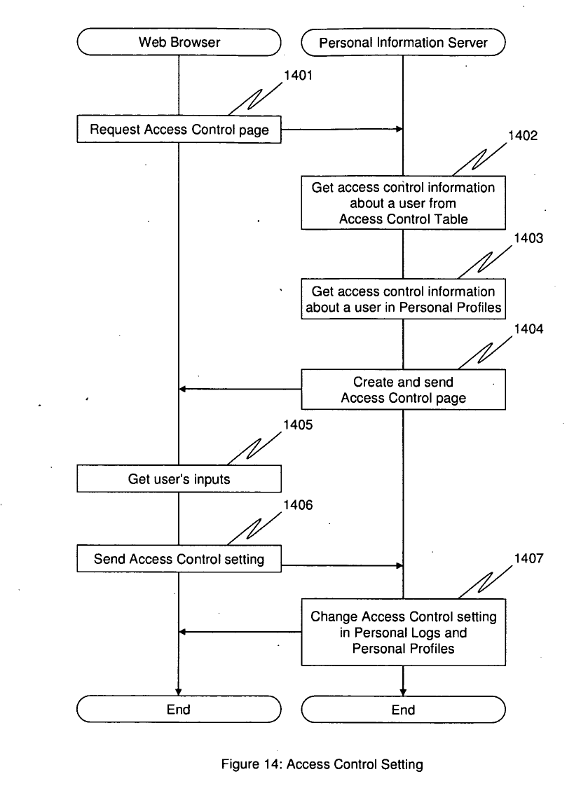

FIG. 14 is a flow chart of changing an access control setting process in the personal information bank. It should be noted that flow chart of the changing an access control setting process as illustrated in FIG. 14 is representative, for example, of computer programming executed at the client 0219, 0222, 0225, and the personal information bank 0208. The computer programming is stored, for example, in memory included in each of the client 0219, 0222, 0225, and the personal information bank 0208. This process is called when a user launches a web browser 0220, 0223, 0226 to change the access control setting.

The changing an access control setting process to change access to the personal logs 0214 by the personal information bank 0208 proceeds as follows:

Step 1401: A web browser 0220, 0223, 0226 sends a request for opening an access control setting page to a personal information server 0209. In the request, a user name is specified.

Step 1402: The personal information server 0209 reads the access control information for personal logs 0214 about the user from the Access control table 0231.

Step 1403: The personal information server 0209 also reads the access control information for personal profiles 0215 about the user from the Personal Profiles database 0215.

Step 1404: The personal information server 0209 creates and sends the access control setting page with the read access control information to the web browser 0220, 0223, 0226.

Step 1405: The web browser 0220, 0223, 0226 shows the page on the display and waits for the user's inputs.

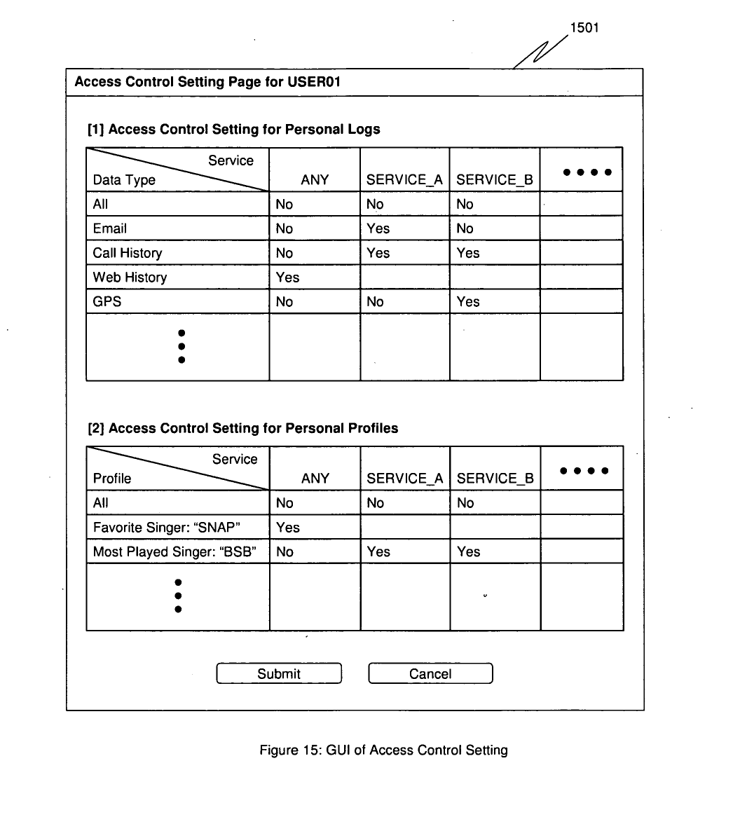

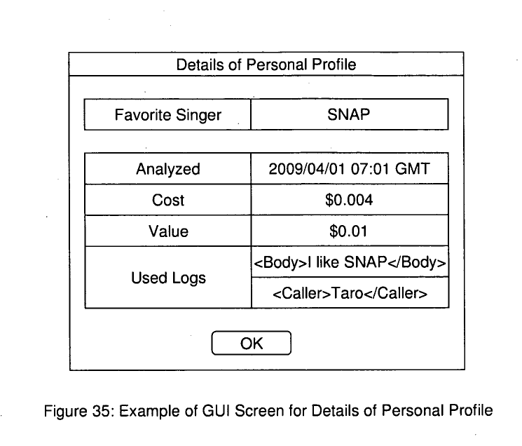

FIG. 15 shows an example of a Graphical User Interface (GUI) of the access control setting page. The page has two parts, [1] Access Control Setting for Personal Logs information and [2] Access Control Setting for Personal Profiles information. Each information is arranged to indicate a plurality of items each item having plural sub-items indicating in corresponding relation a service or data type, whether the service, or personal logs 0214 or profiles can be accessed by any service, and whether the service, or personal logs 0214 or profiles can be accessed by a particular service. Thus, a user can set which service can access what kinds of personal logs 0214 and/or personal profiles 0215. When a user pushes a submit button after setting the desired access with respect to one or more services to personal logs 0214 and/or personal profiles 0215, then the process proceeds to Step 1406. In FIG. 15, when a user clicked a specific personal profile displayed on the screen, more detailed information about the selected personal profile is shown on a different screen. FIG. 35 shows an example of the GUI screen for the details of the personal profile. In this screen, a user can check which personal logs have been used for analyzing a personal profile and its cost and value.

Step 1406: The web browser 0220, 0223, 0226 sends the new access control information to the personal information server 0209.

Step 1407: The personal information server 0209 changes the access control setting in the Access control table 0231 and the Personal Profiles database 0215 according to the request and notifies the completion of the changes to the web browser 0220, 0223, 0226.

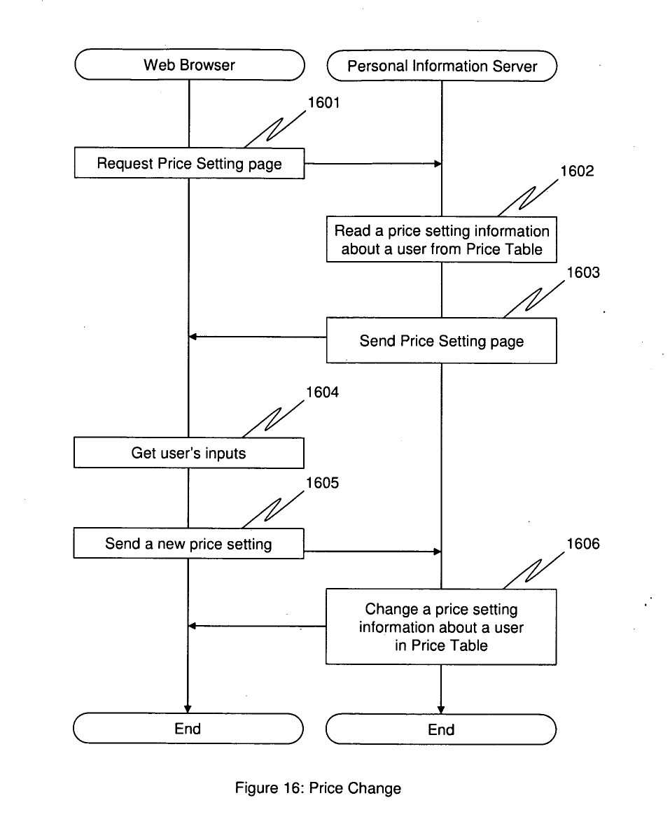

FIG. 16 is a flow chart of a changing a price setting process. It should be noted that flow chart of the changing a price setting process as illustrated in FIG. 16 is representative, for example, of computer programming executed at the client 0219, 0222, 0225, and the personal information bank 0208. The computer programming is stored, for example, in memory included in each of the client 0219, 0222, 0225, and the personal information bank 0208. This process is called when a user launches a web browser 0220, 0223, 0226 to change the price setting for access to a personal log. A user can decide a price for each different type of personal log and the user can receive money when a personal log of the user was accessed by a web site 0201, 0228.

The changing a price setting process proceeds as follows:

Step 1601: A web browser 0220, 0223, 0226 sends a request for opening a price setting page to a personal information server 0209. The request includes a user name.

Step 1602: The personal information server 0209 reads a price setting information for the user from the Price table 0217.

Step 1603: The personal information server 0209 sends the price setting page with the read price setting information to the web browser 0220, 0223, 0226.

Step 1604: The web browser 0220, 0223, 0226 shows the page on the display and waits for the users' input. On the web browser 0220, 0223, 0226, a user can change a price for each different type of a personal log.

Step 1605: The web browser 0220, 0223, 0226 sends the changed price setting information to the personal information server 0209.

Step 1606: The personal information server 0209 updates the entry for the user in the Price table 0217 with the received information and notifies the web browser 0220, 0223, 0226 of completion of the change.

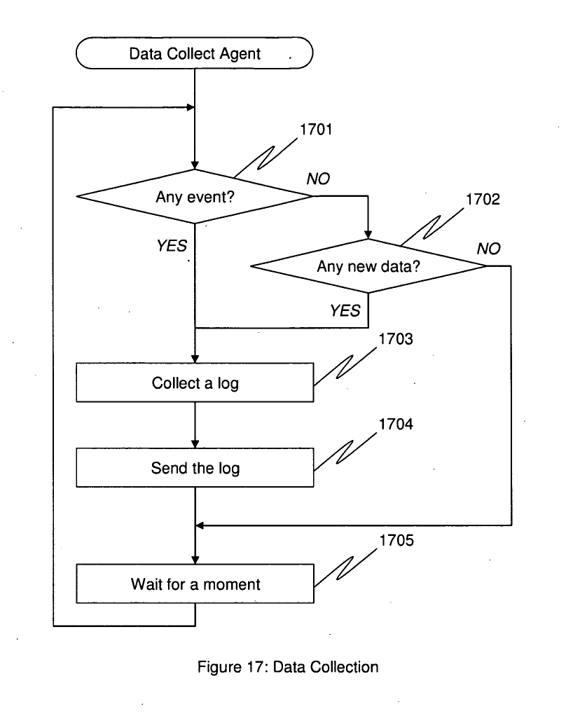

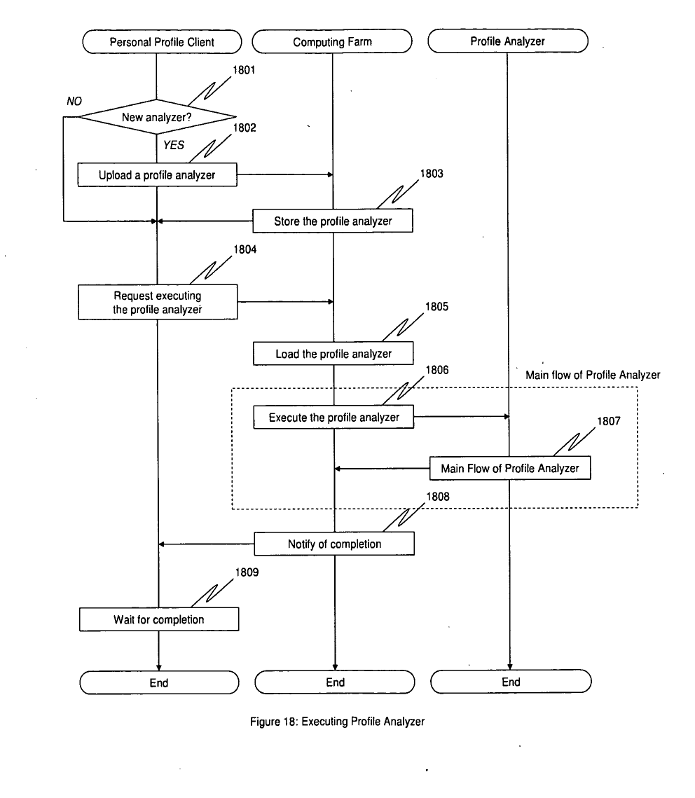

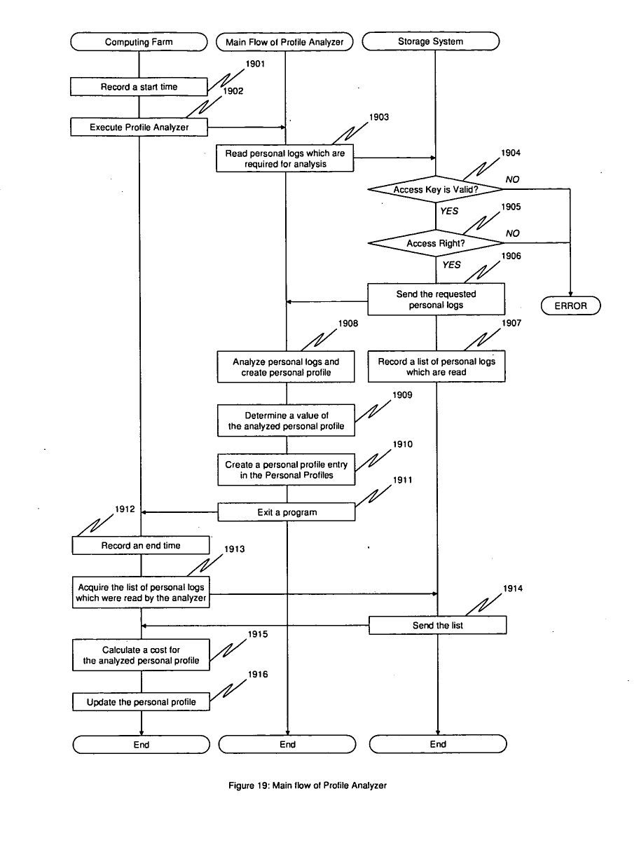

FIG. 17 is a flow chart of a data collect agent process. It should be noted that flow chart of the data collect agent process as illustrated in FIG. 17 is representative, for example, of computer programming executed at the client 0219, 0222, 0225. The computer programming is stored, for example, in memory included in the client 0219, 0222, 0225. This process is called when a user's device is turned on and works in background.

The data collect agent process proceeds as follows:

Step 1701: The data collect agent 0221, 0224, 0227 checks if any new event or predefined user activity has occurred within the client 0219, 0222, 0225. Such event or user activity includes pushing a key button on the client 0219, 0222, 0225, acquiring Global Positioning System (GPS) data, removing a file from the client 0219, 0222, 0225, etc. If any such new event occurs, then the process proceeds to step 1703. If no such new event occurs, then the process proceeds to step 1702.

Step 1702: The data collect agent 0221, 0224, 0227 checks if there is any new data created in data repositories in the client 0219, 0222, 0225. Such repositories include email “in” and “sent” mail boxes, file folders, call history, etc. If any such new data is created, then the process proceeds to step 1703. If no such new data is created, then the process proceeds to step 1705.

Step 1703: The data collect agent 0221, 0224, 0227 creates a new personal log for the new event, predefined user activity or new data. The data collect agent 0221, 0224, 0227 has its certification ID which is assigned by the personal information bank. The data collect agent 0221, 0224, 0227 creates a new certification for the new log by using the certification ID, the current time and the content of the log.

Step 1704: The data collect agent 0221, 0224, 0227 sends the personal log to the personal information server 0209 with a user name, a data type and the calculated certification. The personal information server 0209 stores the log in the Personal Logs database 0214 with a newly assigned Log ID for the log and the current time as a logged time.

Step 1705: The data collect agent 0221, 0224, 0227 waits for a moment in order to reduce workloads caused by the data collect agent 0221, 0224, 0227 and repeats the above described steps beginning with Step 1701.

FIG. 18 is a flow chart for a procedure of uploading a profile analyzer 0211, 0212 to the computing farm 0210 of the personal information bank and executing the profile analyzer 0211, 0212 by the personal profile client 0207. It should be noted that flow chart of the procedure as illustrated in FIG. 18 is representative, for example, of computer programming executed at the web site 0201, 0228, and the computing farm 0210 included in the personal information bank 0208. The computer programming is stored, for example in memory included in each of the web site 0201, 0228, and the computing farm 0210. This procedure is called by the service system 0204 of the web site 0201, 0228 periodically or when a new profile analyzer 0211, 0212 is available so the analyzed personal profiles 0215 are updated.

The procedure proceeds as follows:

Step 1801: A personal profile client 0207 checks if there is any new profile analyzer 0211, 0212 available. If so, then the procedure proceeds to step 1802, if not, then the procedure proceeds to step 1803.

Step 1802: The personal profile client 0207 sends a program of a new profile analyzer 0211, 0212 to the computing farm 0210. In this request, Service ID of the web site 0201, 0228 and ID of the profile analyzer 0211, 0212 are specified.

Step 1803: The computing farm 0210 stores the received program in the storage system 0213 with the provided information.

Step 1804: The personal profile client 0207 requests an execution of a profile analyzer 0211, 0212 to the computing farm 0210. In the request, Service ID of the web site 0201, 0228, ID of the profile analyzer 0211, 0212, a list of subscribed user names and a list of access keys of all of the subscribed users are specified. This information is required when a profile analyzer 0211, 0212 accesses to personal logs 0214. The personal profile client 0207 waits for notice of completion of the execution.

Step 1805: The computing farm 0210 loads the program of the specified profile analyzer 0211, 0212 onto the memory.

Step 1806: The computing farm 0210 executes the program of the specified profile analyzer 0211, 0212.

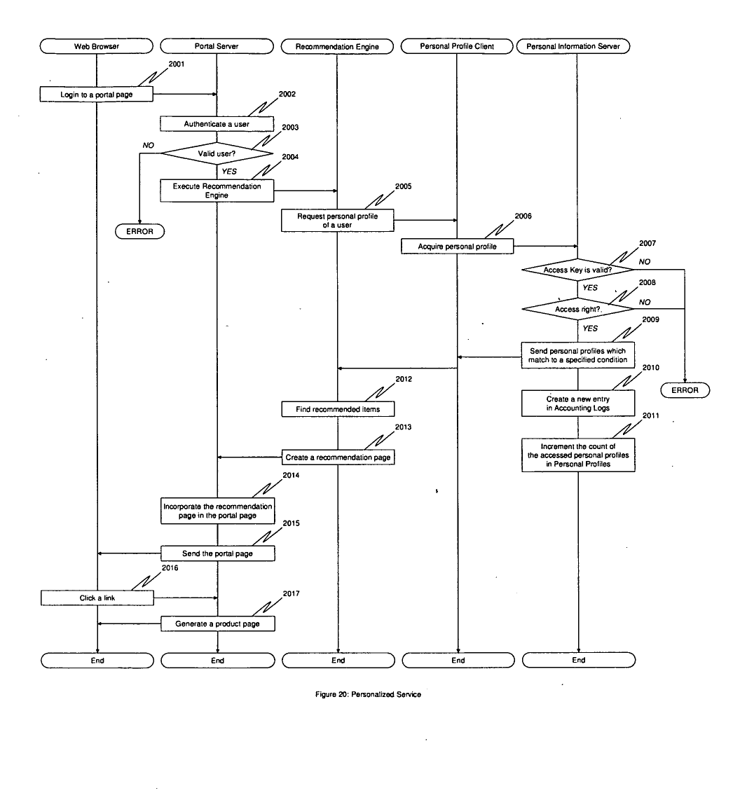

Step 1807: The profile analyzer 0211, 0212 executes various steps as part of its main flow as a result of execution of the program by the computing farm 0210. Details about Step 1806 and Step 1807 are explained in FIG. 19. During Step 1807, new personal profiles are created.

Step 1808: After the completion of execution by the profile analyzer 0211, 0212, the computing farm 0210 sends a notice of completion of execution message to the personal profile client 0207.

Step 1809: After the personal profile client 0207 receives the notice, the personal profile client 0207 exits from this procedure.

FIG. 19 is a flow chart of the details of the various steps executed as part of the main flow of the profile analyzer 0211, 0212. The computing farm 0210 is responsible for measuring Central Processing Unit (CPU) cycle used by the profile analyzer 0211, 0212 and the storage system 0213 is responsible for providing personal logs 0214 while keeping the access control required by users.

The details of the various steps executed as part of the main flow of the profile analyzer 0211, 0212 are as follows:

Step 1901: The computing farm 0210 records a start time of execution of the profile analyzer 0211, 0212.

Step 1902: The computing farm 0210 executes the various steps of the main flow of the profile analyzer 0211, 0212.

Step 1903: The profile analyzer 0211, 0212 reads personal logs 0214 required for analyzing the personal profiles 0215 from a storage system 0213. The profile analyzer 0211, 0212 provides a user name, an access key and a service ID in order to read personal logs 0214 about the user.

Step 1904: The storage system 0213 checks if the access key is valid by referring to the Access key table 0218. If the access key is valid, then the procedure proceeds to Step 1905. If the access key is not valid, then the procedure ends with an error.

Step 1905: The storage system 0213 checks if the service ID is listed in the entry specified by the user name and the type of the requested log in the Access control table 0231, thereby determining if the user has access rights. If the service ID is listed in the entry specified by the user name and the type of the requested log in the Access control table 0231, then the procedure proceeds to Step 1906. If the service ID is not listed in the entry specified by the user name and the type of the requested log in the Access control table 0231, then the procedure ends with an error.

Step 1906: The storage system 0213 sends the requested personal logs 0214 to the profile analyzer 0211, 0212.

Step 1907: The storage system 0213 records a list of the personal logs 0214 read by the profile analyzer 0211, 0212.

Step 1908: The profile analyzer 0211, 0212 analyzes the read personal logs 0214 and creates personal profiles 0215. One example of creating personal profiles 0215 from the personal logs 0214 is to search keywords appearing in the logs and count the number of appearances of each keyword in the personal logs 0214 and select the keyword where the number of appearances is larger than a predetermined threshold, and use the keyword as a favorite of a user. If the keyword is a name of a singer, the word is considered as a favorite singer. A dictionary is used to determine if the keyword is a name of a singer.

Step 1909: The profile analyzer 0211, 0212 determines a value of the personal profile according to a content of the profile. For example, a value can be decided by a uniqueness of the content. If the content has a unique information, it is considered that the information is much valuable than commonly appeared information. One example of determining the uniqueness of the content is to compare multiple different contents and check if these contents have same keyword or not. If one content has a keyword which does not appear in other contents, the content is considered as unique. On the other hand, if the content has a keyword which appears to many other contents, the content is considered as not unique. In a case of a favorite singer, if many users have the same preference “SNAP”, the value of the information is low but if only one user has the unique preference “BSB”, the value of the information is considered high.

Step 1910: The profile analyzer 0211, 0212 creates a new entry for storing the analyzed personal profile in the Personal Profile database. The profile analyzer 0211, 0212 fills the columns, Profile ID with a unique profile ID assigned by the storage system 0213, User Name with a user name of the personal profile, Created by with the service ID of the subscribed service, ID of Analyzer with the ID of the profile analyzer 0211, 0212, Analyzed Time with the current time, Value with the value determined in Step 1909 and Profile with the content of the analyzed personal profile.

Step 1911: The profile analyzer 0211, 0212 exits.

Step 1912: The computing farm 0210 records the end time of the execution.

Step 1913: The computing farm 0210 acquires a list of the personal logs 0214 which were read by the profile analyzer 0211, 0212 from the storage system 0213.

Step 1914: The storage system 0213 sends the requested list to the computing farm 0210.

Step 1915: The computing farm 0210 calculates a cost for the analyzed personal profile by summing all of the costs assigned to the personal logs 0214 in the list.

Step 1916: The computing farm 0210 updates the personal profile in the Personal Profiles database 0215 with CPU Cycle with the duration of the execution time, Cost with the summed cost in Step 1915, Counts with 0, Used Logs with the list in Step 1914 and Access Control as default value determined by logical AND of all of access control settings of the used personal logs 0214.

FIG. 20 is a flow chart for realizing Personalized Service. It should be noted that flow chart of the Personalized Service as illustrated in FIG. 20 is representative, for example, of computer programming executed at the client 0219, 0222, 0225, the web site 0201, 0228, and the personal information bank 0208. The computer programming is stored, for example in memory included in each of the client 0219, 0222, 0225, the web site 0201, 0228, and the personal information bank 0208. This procedure starts when a user opens a portal page of a subscribed web site 0201, 0228 by launching a web browser 0220, 0223, 0226.

The Personalized Service proceeds as follows:

Step 2001: A web browser 0220, 0223, 0226 logs in to portal page with a subscription name and a password of a user.

Step 2002: A portal server 0205 receives the subscription name and the password and then checks if the user is a valid user by referring to the Subscription Table 0203.

Step 2003: If the user is a valid user, the procedure proceeds to Step 2004. If the user is not a valid user, then the procedure ends with an error.

Step 2004: The portal server 0205 executes a recommendation engine 0206 with a user name corresponding to the subscription name. The user name is used for identifying the user in the personal information bank.

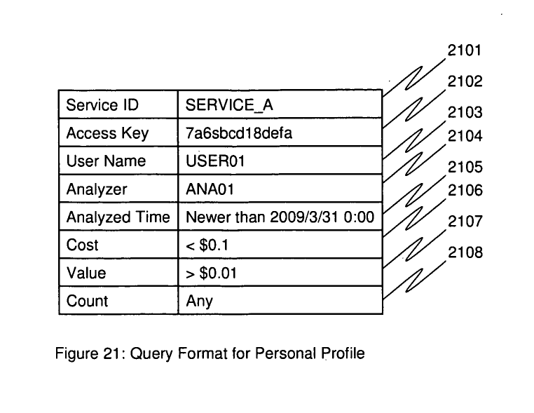

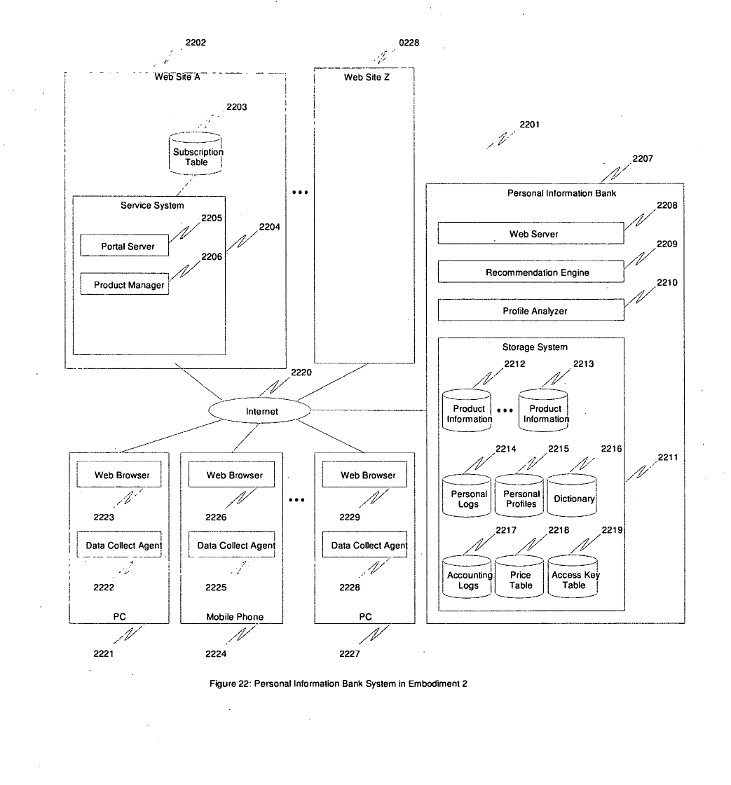

Step 2005: The recommendation engine 0206 requests a personal profile client 0207 for accessing personal profiles 0215 related to the user name. The recommendation engine 0206 creates a query message sent to the personal information server 0209. An example of the query is shown in FIG. 21. Details of FIG. 21 are explained below.

Step 2006: The personal profile client 0207 sends the query to the personal information server 0209 via the Internet. The query includes a user name, an access key and a service ID associated to the subscription.

Step 2007: The personal information server 0209 checks if the access key is valid. If the access key is valid, then the procedure proceeds to Step 2008. If access key in not valid, then the procedure ends with an error.

Step 2008: The personal information server 0209 checks if the provided service ID is listed in the access control setting of the requested personal profile in the Personal Profiles database 0215. If the provided service ID is listed in the access control setting of the requested personal profile in the Personal Profiles database 0215, then the procedure proceeds to Step 2009. If the provided service ID is not listed in the access control setting of the requested personal profile in the Personal Profiles database 0215, then the procedure ends with an error.

Step 2009: The personal information server 0209 sends the requested personal profiles 0215 to the personal profile client 0207.

Step 2010: The personal information server 0209 creates a new entry in the Accounting Logs database with Account Log ID with a uniquely assigned account log ID, Profile ID with the requested personal profile, Used by with the service ID, Used Time with the current time and Cost with a cost of the requested personal profile if the service ID of the requester is same to the service ID of the requested personal profile or with a sum of a cost and a value of the requested personal profile if they are different. Calculation of the cost is explained in FIG. 3.

Step 2011: The personal information server 0209 increments the count of the requested personal profile in the Personal Profiles database 0215 by one.

Step 2012: The recommendation engine 0206 receives the personal profiles 0215 and searches items within the Product information database 0202 by matching information in the personal profiles 0215 with the descriptions of the products in the Product information database 0202. For example, if the personal profile indicates that the user likes “SNAP”, then the recommendation engine 0206 searches a keyword “SNAP” with the descriptions. Any products which have descriptions containing “SNAP” are candidates for recommendations.

Step 2013: The recommendation engine 0206 creates a part of a web page which lists the items found in Step 2012 as recommendations for the user.

Step 2014: The portal server 0205 incorporates the recommendation page created by the recommendation engine 0206 in the portal page.

Step 2015: The portal server 0205 sends the portal page to the web browser 0220, 0223, 0226 as a response to the login request.

Step 2016: The web browser 0220, 0223, 0226 shows the portal page on the display and receives a click on a link in the portal page by a user. The web browser 0220, 0223, 0226 requests a web page specified by the clicked link to the portal server 0205.

Step 2017: The portal server 0205 sends the requested web page to the web browser 0220, 0223, 0226.

It should be noted that in this embodiment, costs for accessing the personal profile are charged when the portal page is created. Even though a user does not click any of the links to the recommended items, a web site 0201, 0228 needs to pay for the personal profile. In the Embodiment 2, it is realized that only when a user clicked a link, the personal information bank charges the web site 0201, 0228 for the cost for accessing personal profiles 0215 which were used for creating the links. In a case of the Embodiment 2, the investment on the personal profiles 0215 by the web site 0201, 0228 can be improved.

FIG. 21 is an example of a query message created by a recommendation engine 0206 in order to filter personal profiles 0215 to be read. In the query message, Service ID 2101, Access Key 2102, User Name 2103, Analyzer 2104, Analyzed Time 2105, Cost 2106, Value 2107 and Count 2108 are specified. The personal information server 0209 provides only personal profiles 0215 which match to these conditions. The most important condition in order to save cost is the Value. Because no personal profile client 0207 can read content of the personal profile before paying the cost, the value determined by the profile analyzer 0211, 0212 indicates how important the personal profile is for the web site 0201, 0228. Because the profile analyzer 0211, 0212 is executed within the personal information bank, it can access to any personal logs 0214 and personal profiles 0215 as long as it has an access privilege.

It should be noted that in the Embodiment 2, the value field is not necessary but a recommendation engine 0206 reads all of the personal profiles 0215 without filtering. However they do not need to pay for the costs just by reading the personal profile. They pay for the cost only when a created link by using the personal profiles 0215 was clicked by a user. So they can save the cost.

At this point, all of necessary tables and procedures for the Embodiment 1 have been explained. From this point, the Embodiment 2 is described.

FIG. 22 shows the system architecture of the personal information bank system 2201 in the Embodiment 2. Embodiment 2 illustrated in FIG. 22 is similar to Embodiment 1 illustrated in FIG. 2 with the exception that the service system 0204 illustrated in FIG. 2 is replaced by a service system 2204 having a subscription table 2203, a portal server 2205 and a product manager 2206, and the personal information bank 0208 as illustrated in FIG. 2 is replaced by the personal information bank 2207 having a web server 2208, recommendation engine 2209, profile analyzer 2210, and storage system 2211 which includes product information 2212, 2213, personal logs 2214, personal profiles 2215, dictionary 2216, accounting logs 2217, price table 2218 and access key table 2219 as per FIG. 22.

In the Embodiment 2, the personal information bank provides creating a recommendation page for the web sites 2202, 0228 according to the internally analyzed personal profiles 2215 and the product information databases 2212, 2213 provided from the web sites 2202, 0228. It is good for small web sites 2202, 0228 to outsource personalized services to the personal information bank because they do not have enough money and skill to build their own recommendation system. Another aspect of the Embodiment 2 is that the web site 2202, 0228 pays for the personal logs 2214 and the personal profiles 2215 used for creating recommendation pages only when users clicked the recommended items so the web sites 2202, 0228 can save the costs.

In the Embodiment 2 the service System 2204 has the portal server 2205, the product manager 2206 and the subscription table 2203, wherein the portal server 2205 handles a subscription of a user and provides a portal page personalized to the user. The recommendation part in the portal page is created by the recommendation engine 2209 working on the personal information bank. The product manager 2206 uploads the latest product information 2212, 2213 in the storage system 2211 of the personal information bank and this product information is used for finding recommendations. All of an access to a clicked link is handled by the web server 2208 working on the personal information bank because the links in the recommended items are directed to the web server 2208.

In the personal information bank, personal logs 2214 collected by data collect agents 2222, 2225, 2228 are stored in the Personal Logs database 2214. The profile analyzer 2210 analyzes the personal logs 2214 and produces the personal profiles 2215. The personal profiles 2215 are stored in the Personal Profiles database 2215. The profile analyzer 2210 updates personal profiles periodically.

All of the tables in the Embodiment 1 are also applied to the Embodiment 2.

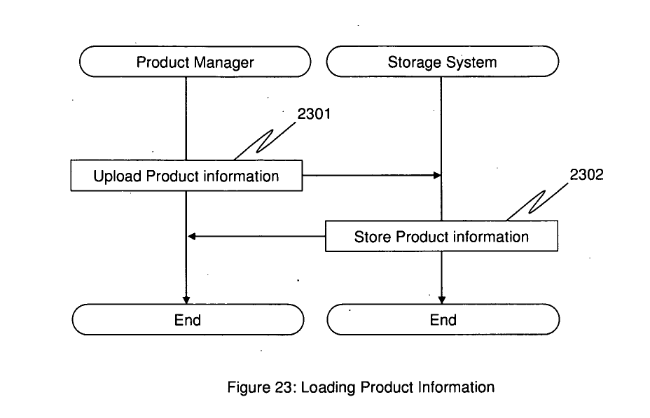

FIG. 23 is a flow chart for uploading the product information database 2212, 2213. It should be noted that the flow chart of this procedure as illustrated in FIG. 23 is representative, for example, of computer programming executed at the web site 2202, 0228, and the personal information bank 2207. The computer programming is stored, for example in memory included in each of the web site 2202, 0228, and the personal information bank 2207. This procedure is called by the service system 2204 when an updated product information database 2212, 2213 is available.

The uploading the product information database 2212, 2213 proceeds as follows:

Step 2301: The product manager 2206 uploads the new product information database 2212, 2213 to the storage system 2211.

Step 2302: The storage system 2211 stores the database.

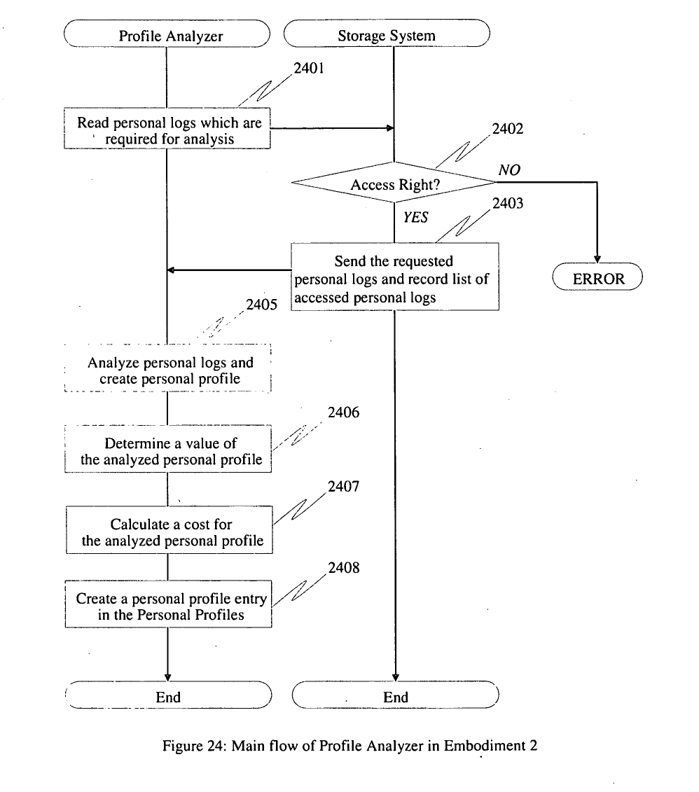

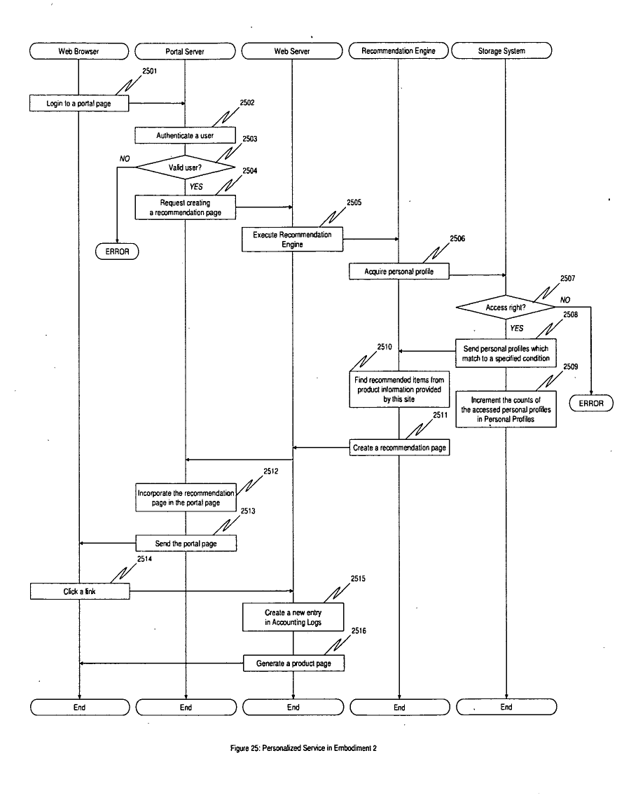

FIG. 24 is a flow chart for executing a profile analyzer 2210 and producing personal profiles. It should be noted that flow chart of the procedure as illustrated in FIG. 24 is representative, for example, of computer programming executed at the personal information bank 2207. The computer programming is stored, for example in memory included in the personal information bank 2207. This procedure is called periodically by the profile analyzer 2210 which is running in background.

The executing a profile analyzer 2210 and producing personal profiles proceeds as follows:

Step 2401: The profile analyzer 2210 reads the personal logs 2214 which are required for analysis. The profile analyzer 2210 can read all of the stored personal logs 2214 without any restriction because this is a program provided by the personal information bank and is secure and reliable. However it is possible for a user to set the access control information for the personal logs 2214 not to be accessed by the profile analyzer 2210.

Step 2402: The storage system 2211 checks if the profile analyzer 2210 can read the requested personal logs 2214 by referring to the Access Control Table. If the profile analyzer 2210 can read the requested personal logs 2214 by referring to the Access Control Table, then the procedure proceeds to Step 2403. If the profile analyzer 2210 can not read the requested personal logs 2214 by referring to the Access Control Table, then the procedure ends with an error.

Step 2403: The storage system 2211 sends the requested personal logs 2214 to the profile analyzer 2210 and records a list of accessed personal logs 2214.

Step 2405: The profile analyzer 2210 analyzes the personal logs and creates personal profiles 2215. This analysis is not focusing on any specific service such as in the Embodiment 1 but provides personal profiles 2215 which can be used for wider applications.

Step 2406: The profile analyzer 2210 determines a value of the personal profile. This value is also determined from a perspective of generic uses.

Step 2407: The profile analyzer 2210 calculates a cost for the personal profile based on the costs of the accessed personal profiles 2215.

Step 2408: The profile analyzer 2210 creates a new entry in the Personal Profiles database 2215.

FIG. 25 is a flow chart for the personalized service in the Embodiment 2. It should be noted that flow chart of the personalized service as illustrated in FIG. 25 is representative, for example, of computer programming executed at the client 2221, 2224, 2227, the web site 2202, 0228, and the personal information bank 2207. The computer programming is stored, for example in memory included in each of the client 2221, 2224, 2227, the web site 2202, 0228, and the personal information bank 2207. This procedure is called when a user logs in to the portal site and loads a portal page on the web browser 2223, 2226, 2229.

The personalized service proceeds as follows:

Step 2501: A web browser 2223, 2226, 2229 logs in the portal page with a subscription name and a password.

Step 2502: A portal server 2205 checks if the provided subscription name and password are listed in the Subscription table 2203.

Step 2503: If the user is a valid user, then the procedure proceeds to step 2504, if not, then the procedure ends with an error.

Step 2504: The portal server 2205 requests creating a recommendation page to the web server 2208 of the personal information bank with a user name corresponding to the subscription name and the service ID of the portal site.

Step 2505: The web server 2208 executes the recommendation engine 2209 with the user name and the service ID.

Step 2506: The recommendation engine 2209 acquires personal profiles 2215 related to the user name from the storage system 2211. In the request, service ID is specified for access control.

Step 2507: The storage system 2211 checks if the requested personal profile allows an access from the service ID. If not, the procedure ends with an error.

Step 2508: The storage system 2211 provides the requested personal profiles 2215 to the recommendation engine 2209.

Step 2509: The storage system 2211 increments the count of the requested personal profile in the Personal Profiles database 2215.

Step 2510: The recommendation engine 2209 finds items from the product information database 2212, 2213 corresponding to the service ID based on the personal profiles 2215.

Step 2511: The recommendation engine 2209 creates a recommendation page with the found items and the page is sent to the portal server 2205.

Step 2512: The portal server 2205 incorporates the recommendation page in the portal page.

Step 2513: The portal server 2205 sends the portal page to the web browser 2223, 2226, 2229 as a response to the login request.

Step 2514: The web browser 2223, 2226, 2229 shows the portal page on the display and receives a click on a link in the portal page by a user. The web browser 2223, 2226, 2229 requests a web page specified by the clicked link to the web server 2208 of the personal information bank.

Step 2515: The web server 2208 creates a new entry in the Accounting Logs with a cost calculated from the costs of the used personal logs 2214 and the value of the personal profile.

Step 2516: The web server 2208 provides a requested web page to the web browser 2223, 2226, 2229.

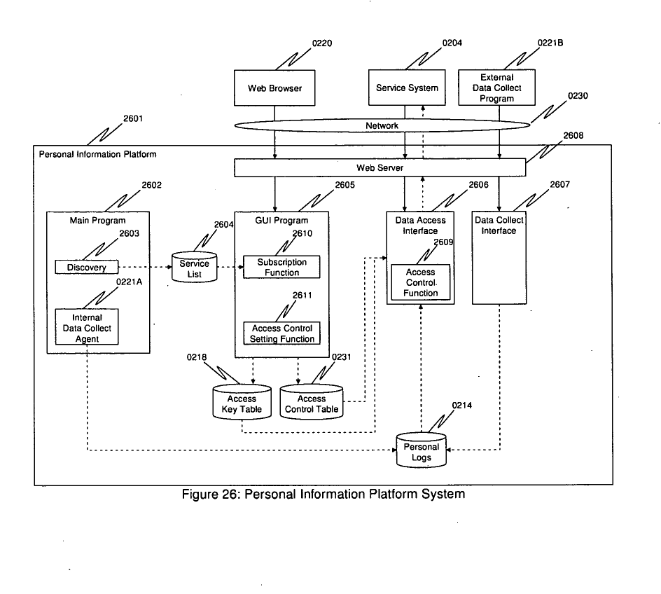

FIG. 26 shows another embodiment, Embodiment 3, in which the personal information bank system of the Embodiment 1 is simplified. Embodiment 3 provides a personal information platform system 2601 which collects personal logs 0214 independently from the service system 0204 which forms a part of each website 0201, 0228 and provides the collected personal logs 0214 to each service system 0204 with access control for the personal logs 0214. Thus, in Embodiment 3, there is no personal profile or personal information bank. Embodiment 3 focuses on collecting personal logs 0214 and providing the logs to each service system 0204. Further, Embodiment 3 focuses on one user, meaning this system exists at the client 0219, 0222, 0225 being used by the user.

The personal information platform 2601 includes Main Program 2602, GUI Program 2605, Data Access Interface 2606, Data Collect Interface 2607, Web Server 2608, Service List 2604, Access Key Table 0218, Access Control Table 0231 and Personal Logs 0214.

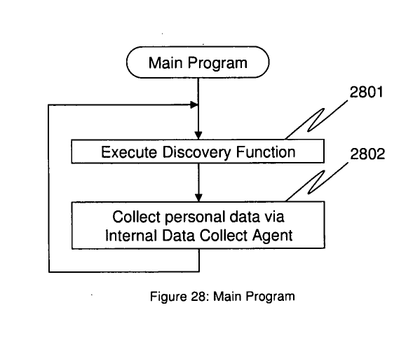

FIG. 28 shows a flowchart of the Main Program. It should be noted that flow chart of the Main Program as illustrated in FIG. 28 is representative, for example, of computer programming executed at the client 0219, 0222, 0225. The computer programming is stored, for example in memory included in the client 0219, 0222, 0225.

The Main Program has two functions, namely Discovery 2603 and Internal Data Collect Agent 0221 A functions. The Discovery function 2603 creates a list of service systems 0204 available on a network or within the client 0219, 0222, 0225, which can as previously described be a personal device such as a mobile phone and a personal computer, and the discovered information is stored in the Service List 2604 (Step 2801). Internal Data Collect Agent 0221 A collects various types of data which are created and stored by various types of applications installed and executed in the client 0219, 0222, 0225 and stores them with common Extensible Markup Language (XML) format to Personal Logs 0214 (Step 2802). Internal Data Collect Agent 0221 A uses proprietary Application Programming Interfaces (APIs) to access data created by an application.

Collected data is not restricted to only data but also user's actions such as pushing a particular button of a client 0219, 0222, 0225 which may be a mobile phone. There are multiple Internal Data Collect Agents 0221A in the system and each agent collects one specific data type periodically. A common format of a personal log contains a common data part in which information which are common to all data types are written and a unique data part in which information which are unique to a specific application are written. For example, a created date of data is considered as common information and a name of a song track is considered unique information. Each personal log is given a unique ID within a system.

The GUI Program 02605 has two functions, namely a Subscription Function 2610 and an Access Control Setting Function 2611. The Subscription Function 2610 creates a list of services available from the Service List 2604 and shows the list on the Web Browser 0220. A user can see the list and select a service system 0204 to subscribe from the Web Browser 0220. The Access Control Setting Function 2611 generates an access key for each subscribed service and stores it in Access Key Table 0218 and sets access control information to Access Control Table 0231.

The Data Access Interface 2606, 022607 accepts a data access request from Service System 0204 and checks if the provided access key is valid. If the access key is valid, then the service system 0204 is permitted to access to the requested types of data by referring to the Access Key Table 0218 and Access Control Table 0231. If the access is permitted, then the requested data stored in Personal Logs 0214 is sent to the service system 0204. If the access is not permitted, then the request is denied.

The Data Collect Interface 2607 accepts a request from an external data collect program 02218 which is running outside of client 0219, 0222, 0225, or running independently from Personal Information Platform 2601. The external data collect program 02218 collects data about a user from the Internet or from sensors equipped in an environment or location, for example, a house, and stores the collected data to Personal Logs 0214. The data collect interface 2607 provides a way for the external data collect program 02218 to send the collected data to Personal Information Platform 2601 and stores the collected data to Personal Logs 0214.

The web server 2608 works as a server which accepts requests from web browser 0220, service system 0204 and external data collect program 02218 and transfers the requests to appropriate destinations in the Personal Information Platform 2601 such as the GUI Program 2605, Data Access Interface 2606 and Data Collect Interface 2607 according to a request type.

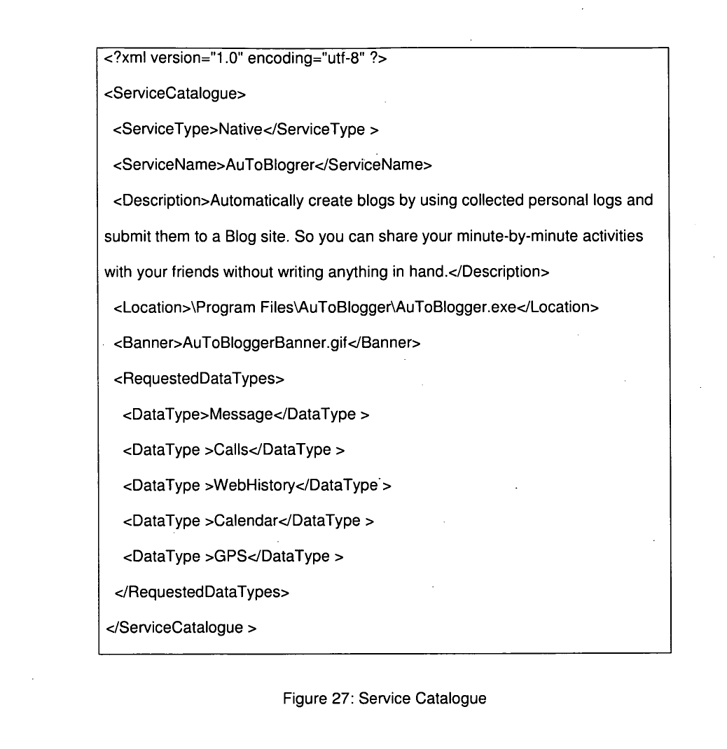

The Service List 2604 is a set of Service Catalogues collected by various ways. An example of a service catalogue is shown in FIG. 27. The service catalogue can be formatted in XML and has information required for a user to know the availability of a service and a description of the service. A service catalogue can have information such as ServiceType, ServiceName, Description, Location, Banner and RequestedDataTypes.

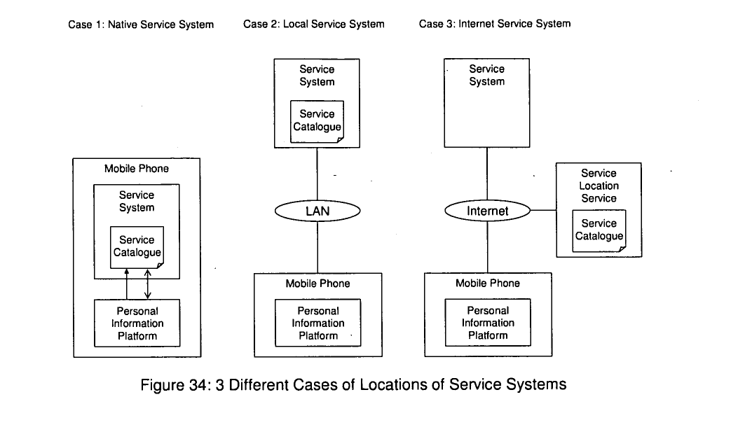

ServiceType indicates where this service is running as shown in FIG. 34. ServiceType can be “Native”, case 1 as illustrated in FIG. 34, “LAN”, case 2 as illustrated in FIG. 34, and “Internet”, case 3 as illustrated in FIG. 34. In a case of “Native”, the service system 0204 is running on the same client 0219, 0222, 0225 as the Personal Information Platform 2601, for example, on the same mobile phone. In a case of “LAN”, the service system 0204 is attached to the same local area network to which the client 0219, 0222, 0225 is attached. In a case of “Internet”, the service system 0204 is attached to the Internet.

ServiceName is a name of a service. Description explains what functions or services this service provides to a user. Location specifies how to subscribe to this service. In a case of “Native”, Location specifies a name of a program installed in the client 0219, 0222, 0225. In a case of “LAN” and “Internet”, a Uniform Resource Identifier (URI) for a subscription page is specified. Banner specifies a picture of a logo of a service. RequestedDataTypes lists data types which a service needs to access so a user can know which data types are going to be accessed by a service if the user subscribed to the service.

Access Key Table and Access Control Table are same as in Embodiment 1 except for these tables in Embodiment 3 store information for only one user which is an owner and/or user of the client 0219, 0222, 0225 on which Personal Information Platform 2601 is running.

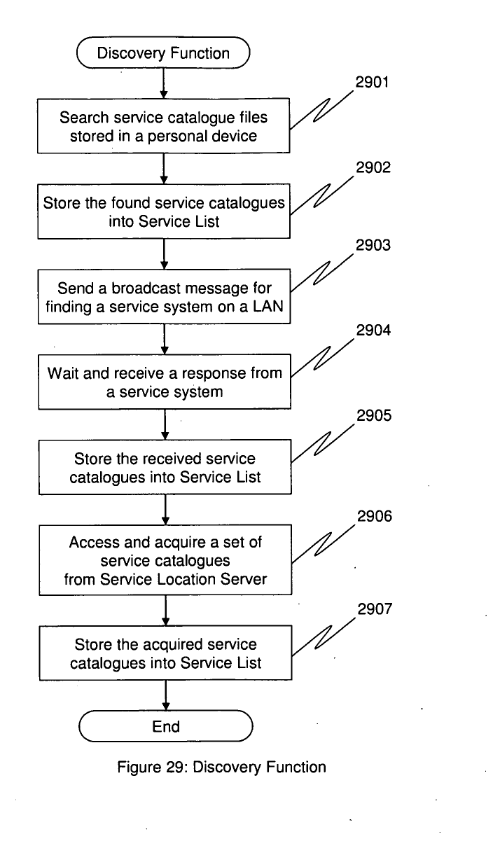

FIG. 29 shows a flowchart of Discovery function 2603 in more detail. It should be noted that flow chart of the Discovery function as illustrated in FIG. 29 is representative, for example, of computer programming executed at the client 0219, 0222, 0225. The computer programming is stored, for example in memory included in the client 0219, 0222, 0225.

In Step 2901, the Discovery function 2603 searches service catalogue files stored in client 0219, 0222, 0225 by referring to an extension of a file name. In Step 2902, the Discovery function 2603 stores the found service catalogues into Service List 2604. Steps 2901 and 2902 correspond to Case 1 “LAN” as described above. In Step 2903, the Discovery function 2603 sends a broadcast message to a LAN to which a client 0219, 0222, 0225 is connected. The message is for finding service systems 0204 connected to the same LAN. In Step 2904, the Discovery function 2603 waits and receives a reply from a service system 0204 with a service catalogue file of the service system 0204. In Step 2905, the Discovery function 2603 stores the received service catalogue into Service List 2604. Steps 2903, 2904 and 2905 correspond to Case 2 “LAN” as described above. In Step 2906, the Discovery function 2603 accesses to a URI of Service Location Service and acquires a set of service catalogues which are provided by Service Systems 0204 to Service Location Service. In Step 2907, the Discovery function 2603 stores the acquired service catalogues to Service List 2604. Steps 2906 and 2907 correspond to Case 3 “Internet” as described above. The URI of Service Location Service is provided by a user to Personal Information Platform 2601.

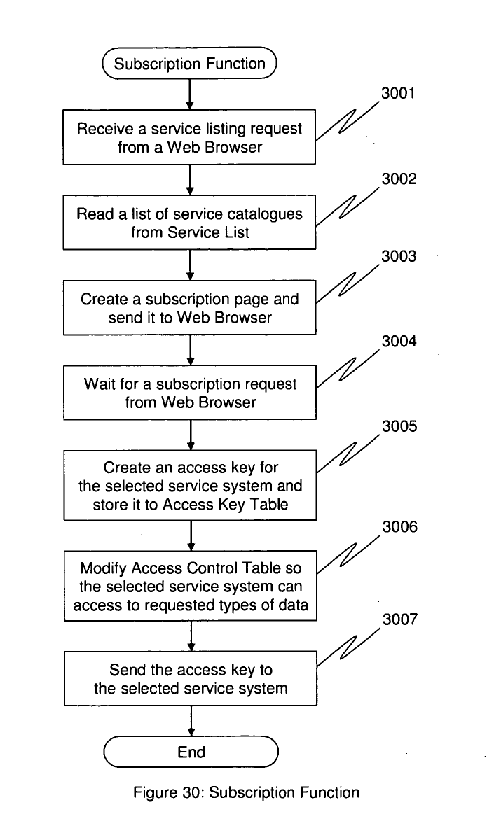

FIG. 30 shows a flowchart of Subscription function 2610. It should be noted that flow chart of the Subscription function 2610 as illustrated in FIG. 30 is representative, for example, of computer programming executed at the client 0219, 0222, 0225. The computer programming is stored, for example, in memory included in the client 0219, 0222, 0225.

In Step 3001, the Subscription function 2610 receives a service listing request from a Web Browser. In Step 3002, the Subscription function 2610 reads a list of service catalogues in Service List 2604. In Step 3002, the Subscription function 2610 creates a subscription page on which a list of available service systems 0204 are listed and sends this page to the Web Browser 0220. In Step 3003, the Subscription function 2610 waits for a subscription request from the Web Browser 0220. In Step 3005, the Subscription function 2610 creates an access key for the service system selected by a user and stores the key in the Access Key Table 0218. In Step 3006, the Subscription function 2610 modifies the Access Control Table 0231 so the selected service system can access the requested data types of personal logs 0214. The requested data types are specified in the service catalogue. In Step 3007, the Subscription function 2610 sends the access key to the service system 0204.

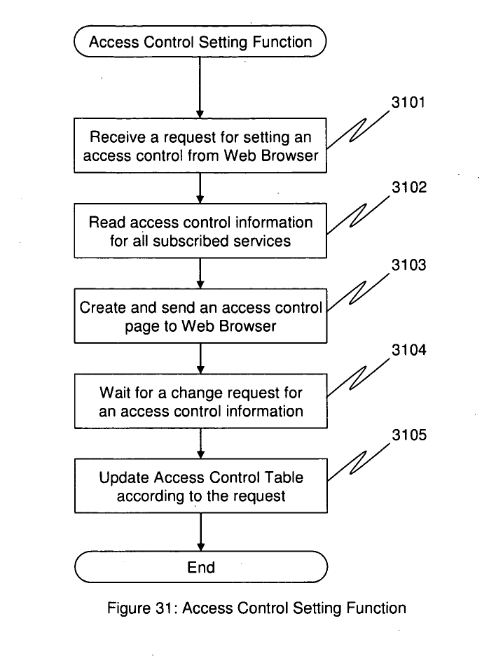

FIG. 31 shows a flowchart of an Access Control Setting function 2611. It should be noted that flow chart of the Access Control Setting function 2611 as illustrated in FIG. 31 is representative, for example, of computer programming executed at the client 0219, 0222, 0225. The computer programming is stored, for example, in memory included in the client 0219, 0222, 0225.

In Step 3101, the Access Control Setting function 2611 receives a request for setting access control from Web Browser 0220. In Step 3102, the Access Control Setting function 2611 reads access control information for all subscribed services from Access Control Table 0231. In Step 3103, the Access Control Setting function 2611 creates an access control page on which all data types of personal logs 0214 and all subscribed services are listed. Then the Access Control Setting function 2611 sends the page to the Web Browser 0220. In Step 3104, the Access Control Setting function 2611 waits for a change request for an access control information from the Web Browser 0220. In Step 3105, the Access Control Setting function 2611 updates Access Control Table 0231 according to the request.

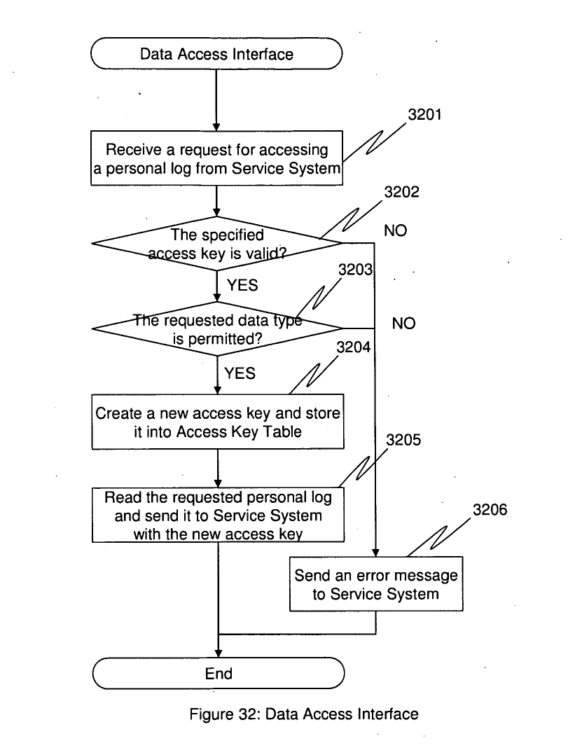

FIG. 32 shows a flowchart of Data Access Interface 2606. It should be noted that the flow chart of the Data Access Interface 2606 as illustrated in FIG. 32 is representative, for example, of computer programming executed at the client 0219, 0222, 0225. The computer programming is stored, for example, in memory included in the client 0219, 0222, 0225.

In Step 3201, the Data Access Interface 2606 receives a request for accessing a personal log 0214 from the Service System 0204. In Step 3202, the Data Access Interface 2606 checks if the access key provided with the request is valid or not by comparing it with an entry for the Service System 0204 in Access Key Table 0218. If the key is not valid, then the Data Access Interface 2606 proceeds to Step 3206 wherein it sends an error message to the Service System 0204. If the access key is valid, then the Data Access Interface 2606 proceeds to Step 3203 wherein it checks if the data types requested by the Service System 0204 are permitted for the Service System 0204 by checking against entries in the Access Control Table 0218. If the data types requested by the Service System 0204 are not permitted, then the Data Access Interface 2606 proceeds to Step 3206 wherein an error message is sent to the Service System 0204. If the data types requested by the Service System 0204 are permitted, then the Data Access Interface 2606 proceeds to Step 3204 wherein a new access key is created for the Service System 0204 and is stored in Access Key Table 0231. In Step 3205, the Data Access Interface 2606 reads a requested personal log from Personal Logs 0214 and sends it to the Service System 0204 together with the new access key.

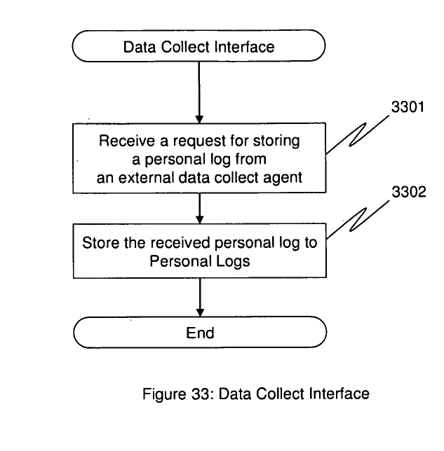

FIG. 33 shows a flowchart of the Data Collect Interface 2607. It should be noted that the flow chart of the Data Collect Interface 2607 as illustrated in FIG. 33 is representative, for example, of computer programming executed at the client 0219, 0222, 0225. The computer programming is stored, for example, in memory included in the client 0219, 0222, 0225.

In Step 3301, the Data Collect Interface 2607 receives a request for storing a new personal log from an External Data Collect Agent 02218. In Step 3302, the Data Collect Interface 2607 stores the received personal log to the Personal Logs 0214.

The present invention can be applied to a web service system which collects data from many users and analyzes the collected data for retrieving rich information and providing the rich information to third parties.

Further, the present invention can be applied to the online storage system in which the stored data is protected and is shared by the third parties.

Still further, present invention can be applied to the personal information database business in which personal data is collected from various sources and selling the information to third parties.

Still further yet, present invention can be applied to the prediction system in which future of the world are predicted based on the collected personal logs.

Even further, present invention can be applied to the intelligence of the enterprises in which activities of the employees are analyzed and their next steps are decided by the computer in order to maximize the performance of them.

While the invention has been described in terms of its preferred embodiments, it should be understood that numerous modifications may be made thereto without departing from the spirit and scope of the present invention. It is intended that all such modifications fall within the scope of the appended claims.

What is claimed is:

1. A personal information bank system comprising:
a plurality of websites, each website being provided by a service system which is connected to a network and each website providing a service;
a plurality of clients, each client accesses said websites via said network to permit a user of the client to use the services provided by said websites, collects logs of use by the user of the services provided by said websites and logs of user activity data, and transmits the logs on the network; and
a personal information bank which collects the logs on the network transmitted by the clients, analyzes the logs and based on the analysis determines a personal profile for each user, and stores the personal profile for each user in a personal profile database,
wherein each website accesses the personal profile database to retrieve a personal profile of a user using the service provided by the website and recommends a product or service to the user using the service provided by the website based on the retrieved personal profile.

2. The personal information bank system according to claim 1, wherein the website includes a personal profile client which acquires a personal profile about a user from the personal information bank.

3. The personal information bank system according to claim 2, wherein the personal profile client uploads a program of a profile analyzer from the personal information bank and initiates an execution of the profile analyzer which reads the logs stored in a personal Logs database and generates and stores personal profiles in the personal profiles database.

4. The personal information bank system according to claim 3, wherein the profile analyzer provides a user name, an access key and a service ID to a storage system in which the logs are stored in order to read the logs about the user from the storage system.

5. The personal information bank system according to claim 4, wherein the storage system checks if the access key provided by the profile analyzer is valid by referring to an Access key table and checks if the user has access,
wherein the storage system checks if the service ID is listed in an entry specified by the user name and the type of requested log in an Access control table, thereby determining if the user has access rights, and
wherein if the access key is valid and the user has access rights, then the storage system permits the profile analyzer to read the logs of the user.

6. The personal information bank system according to claim 5, wherein the profile analyzer analyzes the read logs, creates personal profiles and stores the created personal profiles in the personal profiles database.

7. The personal information bank system according to claim 3, wherein the profile analyzer determines a value of a personal profile according to a content of the personal profile.

8. The personal information bank system according to claim 3, wherein the personal information bank acquires a list of the logs which were read by the profile analyzer from the storage system and calculates a cost for the generated personal profile by summing all of the costs assigned to the read logs.

9. The personal information bank system according to claim 7, wherein the value of a personal profile can be set according to a uniqueness of the content of said personal profile.

10. The personal information bank system according to claim 3, wherein the profile analyzer creates a new entry for storing the generated personal profile in the personal profile database.

11. The personal information bank system according to claim 1, wherein said logs of user activity data include Global Positioning System (GPS) data and information concerning removing a file from the client.

12. The personal information bank system according to claim 1, wherein said personal information bank has stored therein a price table which stores in corresponding relation to each user a price for accessing the logs of the user,
wherein a user can access said price table and change the price for accessing the logs of the user.

13. The personal information bank system according to claim 1, wherein said personal information bank stores access control information which controls access to the logs and personal profiles by indicating for each user and for each service of each website whether said service can access the logs, different types of the logs and/or personal profiles,
wherein said personal information bank, when a user requests a change in the access control information, sends to the client being used by the user a Graphical User Interface (GUI) which permits the user to change the access control information of the logs and the personal profiles, and
wherein said GUI includes a first access control setting part which permits the user to set access control information for controlling access to the logs and different types of the logs and a second access control setting part which permits the user to set access control information for controlling access to the personal profiles.

14. A method in a personal information bank system of collecting logs of the use of services by users provided by a plurality of websites and generating personal profiles of the users based on the collected logs, said method comprising:
collecting logs of use by the users of the services provided by the websites and logs of user activity data, and transmitting the logs via a network to the personal information bank system;
analyzing the logs and determining, based on the analysis, a personal profile for each user and storing the personal profile for each user in a personal profile database; and
permitting each website to access the personal profile database to retrieve a personal profile of a user using a service provided by the website and recommending a product or service to the user using the service provided by the website based on the retrieved personal profile.

15. The method according to claim 14, wherein the website includes a personal profile client which acquires a personal profile about a user from the personal information bank.

16. The method according to claim 15, wherein the personal profile client uploads a program of a profile analyzer from the personal information bank and initiates an execution of the profile analyzer which reads the logs stored in a personal Logs database and generates and stores personal profiles in the personal profiles database.

17. The method according to claim 16, wherein the profile analyzer provides a user name, an access key and a service ID to a storage system in which the logs are stored in order to read logs about the user from the storage system.

18. The method according to claim 17, wherein the storage system checks if the access key provided by the profile analyzer is valid by referring to an Access key table and checks if the user has access,
wherein the storage system checks if the service ID is listed in an entry specified by the user name and the type of requested log in an Access control table, thereby determining if the user has access rights, and
wherein if the access key is valid and the user has access rights, then the storage system permits the profile analyzer to read the logs of the user.

19. The method according to claim 18, wherein the profile analyzer analyzes the read logs, creates personal profiles and stores the created personal profiles in the personal profiles database.

20. The method according to claim 16, wherein the profile analyzer determines a value of a personal profile according to a content of the personal profile.

21. The method according to claim 16, wherein the personal information bank acquires a list of the logs which were read by the profile analyzer from the storage system and calculates a cost for the generated personal profile by summing all of the costs assigned to the read logs.

22. The method according to claim 20, wherein the value of a personal profile can be set according to a uniqueness of the content of said personal profile.

23. The method according to claim 16, wherein the profile analyzer creates a new entry for storing the generated personal profile in the personal profile database.

24. The method according to claim 14, wherein said logs of user activity data include Global Positioning System (GPS) data and information concerning removing a file from the client.

25. The method according to claim 14, wherein said personal information bank has stored therein a price table which stores in corresponding relation to each user a price for accessing the logs of the user,
wherein a user can access said price table and change the price for accessing the logs of the user.

26. The method according to claim 14, wherein said personal information bank stores access control information which controls access to the logs and personal profiles by indicating for each user and for each service of each website whether said service can access the logs, different types of the logs and/or personal profiles,
wherein said personal information bank, when a user requests a change in the access control information, sends to the client being used by the user a Graphical User Interface (GUI) which permits the user to change the access control information of the logs and the personal profiles, and
wherein said GUI includes a first access control setting part which permits the user to set access control information for controlling access to the logs and different types of the logs and a second access control setting part which permits the user to set access control information for controlling access to the personal profiles.

27. A personal information bank system comprising:
a plurality of websites, each website being provided by a service system which is connected to a network and each website providing a service;
a plurality of clients, each client accesses said websites via said network to permit a user of the client to use the services provided by said websites, collects logs of use by the user of the services provided by said websites and logs of user activity data, and transmits the logs on the network; and
a personal information bank which collects the logs on the network transmitted by the clients, analyzes the logs and based on the analysis determines a personal profile for each user, stores the personal profile for each user in a personal profile database, and stores product information of products and services offered by each website,
wherein when a user uses a service provided by a website, said personal information bank refers to the personal profile database to retrieve a personal profile of the user using the service provided by the website and recommends a product or service to the user using the service provided by the website based on the retrieved personal profile and said product information stored in said personal information bank.
